(19) United States
(12) Patent Application Publication
(10) Pub. No.: US 2017/0088472 A1
(43) Pub. Date: Mar. 30, 2017

(54) ROBUST CEMENTITIOUS MATERIALS WITH MOBILE LIQUID-INFUSED BARRIER LAYER

(71) Applicant: President and Fellows of Harvard College, Cambridge, MA (US)

(72) Inventors: Joanna AIZENBERG, Boston, MA (US); Philseok KIM, Waltham, MA (US); Gurminder Kaur PAINK, Mississauga (CA)

(21) Appl. No.: 15/312,589

(22) PCT Filed: May 19, 2015
(86) PCT No.: PCT/US15/31593

§ 371 Date: Nov. 18, 2016

Related U.S. Application Data
(60) Provisional application No. 62/000,350, filed on May 19, 2014.

(51) Int. Cl. C04B 41/00; E04B 1/16; C04B 41/46; B28B 11/04; C04B 41/45; C04B 41/52

(52) U.S. Cl. CPC C04B 41/009; C04B 41/0072; C04B 41/4554; C04B 41/52; C04B 41/46; B28B 11/04; E04B 1/16; E04B 2103/02

(57) ABSTRACT

The permeability of cementitious materials is reduced by chemically functionalizing the surface and infiltrating it with a lubricant. However, the development process was not trivial, where additional steps were required to optimize the cement types used (e.g. geopolymer and Portland cement). It was observed that after the complete modification, the wetting behavior of the cement against water changed from dynamic wetting to hydrophobic (water droplets with water CA>120°. Furthermore, compression testing showed that there was negligible difference in the bulk mechanical properties, more specifically the ultimate strength and the Young's modulus. The result is cementitious materials with omniphobicity and damage-tolerant resistance to permeable fluids.

### CROSS REFERENCE TO RELATED APPLICATION

This application claims priority to U.S. Patent Application 62/000,350 filed on May 19, 2014, which is hereby incorporated by reference in its entirety.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### INCORPORATION BY REFERENCE

All patents, patent applications and publications cited herein are hereby incorporated by reference in their entirety for all purposes in order to more fully describe the state of the art as known to those skilled therein as of the date of the invention described herein.

### FIELD OF THE DISCLOSURE

The present application relates to prolonging the life of structures having cementitious materials.

### BACKGROUND

Concrete is a building block that has been used for centuries: From the construction of the pyramids and coliseum to the modern day sky scrapers, it is an extensively used building material. Today, concrete is the single most widely used material in the world and it is predicted that by the year 2050 the demand for concrete will be four times that in 1990. The wide use of concrete can be attributed to its ability to provide structural stability to systems.

Although concrete has an abundant amount of formulations, the main components are filler materials (fly ash, slag, etc.) and cement, which is used to bind the aggregates together. The most common type of cement currently used is Portland cement (PC). PC is composed of four major phases: tri-calcium silicate (Ca₃SiO₅), β-di-calcium silicate ((3-Ca₂SiO₄), tri-calcium aluminate (CaAl₂O₆) and ferrite solid solution. The reaction with water leads to a poorly defined crystalline structure of calcium silicate hydrate (C—S—H). This is the primary binding phase and controls the strength and hardening of the paste which occurs through simple hydration.

Despite PC's widespread use, due to the large carbon foot-print associated with the production of PC, replacement binders are being explored. One alternative is geopolymers (GP) or simply alkali activated aluminosilicates, a novel type of high performance cement material. Similar to PC, the reaction mechanism for geopolymers is not very well understood, but there have been a number of different models developed to try to model the kinetics of the final structure formed. The polycondensation reaction occurs between an alkaline soluble silicate and aluminosilicate source to form a poly-(sialate-siloxo) cross-linked network. Previous studies have shown that GP obtain their maximum strength much faster compared to PC and that their production has reduced carbon dioxide emissions. Other added benefits of geopolymers compared to PC are that they generally have a higher acid resistance and higher resistance to bacterial attack. Thus, GP is also being explored as a biocompatible material for bone implants.

In both cases the cement surfaces and bulk material are porous and hydrophilic, which inevitably leads to water absorption and the diffusion of undesirable ions into the system causing corrosion and promoting growth of microbial species. All of these effects lead to the decrease in the mechanical stability. Other consequences resulting from increased permeability is the degradation of reinforcement materials used in construction such as steel bars (rebars) that help to increase the structural stability of buildings.

Currently, there are a number of different methods employed to increase the service life of a cementitious material by reducing its permeability. These methods can generally be categorized into three different groups: i) solid material coatings and sealants that provide a physical barrier, ii) pore liners which increase the hydrophobicity of the material, and iii) pore blockers which react with some of the soluble concrete components to form insoluble products. These methods are schematically shown in FIG. 1. However, despite the benefits of these conventional techniques, their longevity is limited because they are susceptible to mechanical, chemical, and thermal damage, and tend to have the highest efficiency only in freshly applied concrete. In addition, concrete structures develop new cracks over time that can act as conduits for water and ion migration. In many cases, those new cracks cannot be effectively mitigated by using conventional approaches based on fixed and immobilized solid barrier layers.

### SUMMARY

The present disclosure can overcome these challenges of the conventional art by providing a slippery liquid infused porous surface (SLIPS) over and within a cementitious material. Because of the porous nature of a cementitious material including its internal porosity, a SLIPS associated with a cementitious material inherently forms a liquid infused barrier (LIB) or an LIB layer over and within the cementitious material. Accordingly, as used herein with respect to cementitious materials, the terms SLIPS and LIB can be used interchangeably. More specifically, a LIB layer can be present over or on top of the cementitious material and within its pores. In some embodiments, the LIB fills at least some of the pores present in the cementitious material below the surface at a depth greater than 100 μm. In some other embodiments, the LIB fills substantially all of the pores in the cementitious material. The mobile liquid of a LIB is labile and can fill in new cracks and conduits as they are formed to provide a fully protected barrier that can be functional for an extended period of time.

In certain embodiments, SLIPS incorporates a chemically-modified nanoporous structure that use capillary forces to retain a top liquid layer in place. In certain embodiments, SLIPS can be used in building materials such as cement, where it can be used to decrease the permeability of the material (inherently decreasing the associated corrosion) while maintaining comparable mechanical strength. The cement-based SLIPS or LIB also has the added benefits of an omniphobic coating with the ability to repel liquids with varying surface tensions and, reduce corrosion of reinforcement materials due to reduced accessibility. In certain embodiments, SLIPS can further be used as anti-fouling coating and significantly decrease the formation of frost and decrease ice adhesion on surfaces resulting in energy and economical savings.

As described herein, certain embodiments of the present disclosure provide SLIPS systems (e.g., LIB systems) based on cementitious materials. The significantly reduced permeability not only can decrease the susceptibility of the material to the diffusion of ions that result in structural instability and corrosion, but also can exhibit omniphobic behavior against a wide range of liquids including water and solvents. These added benefits are gained without compromising the inherent mechanical properties. In addition, the surfaces of cement can be fine-tuned to control the wettability of different areas on the surface of the cement.

Accordingly, the present disclosure provides a method for forming a slippery surface over a cementitious material. The method generally can include providing a cementitious material; treating the cementitious material to remove water from at least 100 μm of the top surface of the cementitious material; chemically functionalizing the cementitious material with one or more functional groups that have a chemical affinity with a liquid; and wetting and adhering the liquid to the chemically functionalized cementitious material to form a liquid layer over the cementitious material. The liquid layer over the cementitious material can include a liquid infused barrier. In addition, the liquid barrier can be contained by applying a coating over the surface instead of chemical functionalization. The methods can include removing the top surface of the cementitious material to remove localized regions of ionic species having a dimension greater than 10 μm.

In various embodiments of the present disclosure, the method of forming a slippery surface over a cementitious material generally includes providing a cementitious material; removing the top surface of the cementitious material to remove localized regions of ionic species having a dimension that is greater than 10 μm and to allow access to pores under the skin layer; chemically functionalizing the cementitious material with one or more functional groups that have a chemical affinity with a liquid; and wetting and adhering the liquid to the chemically functionalized cementitious material to form a liquid layer over and within the cementitious material. The liquid layer over the cementitious material can include a liquid infused barrier formed from the surface to deeper internal areas of cementitious materials. The methods can include treating the cementitious material to remove water from the cementitious material.

Treating the cementitious material to remove water can include heating the cementitious material at a temperature below about 70° C. The methods can include treating the cementitious material to remove water where such treating is carried out for less than about 6 hours. Treating the cementitious material to remove water can include heating the surface of the cementitious material with a flame or bringing the surface in contact with a heated medium or another heated surface.

Removing the top surface of the cementitious material can include grinding, sand blasting, cutting, polishing, or combinations thereof. In certain embodiments, providing a cementitious material includes curing the cementitious material in the presence of water.

In some embodiments of the methods of the present disclosure, the one or more functional groups are selected from organosilicone compounds; long-chain alkyl silanes, amines, thiols, carboxylic acids, phosphonic and sulfonic acids; polyethers; cycloethers; their partially or fully fluorinated derivatives, such as perfluoroalkylsilanes, perfluoroalkylamines, perfluorinated carboxylic acids, fluorinated phosphonic and sulfonic acids, perfluoroalkylsulfides, perfluoroalkylsulfoxides, perfluoroalkylethers, perfluorocycloethers, perfluoropolyethers, perfluoroalkylphosphines, perfluoroalkylphosphine oxides, and combinations thereof. The alkyl or perfluoroalkyl group in these functional groups could be linear or branched and some or all linear and branched groups can be only partially fluorinated. The liquid can be selected from a number of different liquids. For example, perfluorinated or partially fluorinated hydrocarbons (fluorinated oils), or organosilicone compounds (eg. silicone oils), low molecular weight hydrocarbons, or long-chain hydrocarbons and their derivatives (e.g., mineral oils, alkyl petroleum oils, vegetable oils), and combinations thereof. In particular, the tertiary perfluoroalkylamines (such as perfluorotri-n-pentylamine, FC-70 by 3M, perfluorotri-n-butylamine FC-40, etc), perfluoroalkylsulfides and perfluoroalkylsulfoxides, perfluoroalkylethers, perfluorocycloethers (such as FC-77) and perfluoropolyethers (such as Krytox family of lubricants by DuPont, Fomblin family of lubricants by Solvay), perfluoroalkylphosphines and perfluoroalkylphosphineoxides as well as their mixtures can be used for these applications, as well as their mixtures with perfluorocarbons and any and all members of the classes mentioned. In addition, long-chain perfluorinated carboxylic acids (e.g., perfluorooctadecanoic acid and other homologues), fluorinated phosphonic and sulfonic acids, fluorinated silanes, and combinations thereof can be used as the liquid. The perfluoroalkyl group in these compounds could be linear or branched and some or all linear branched groups can be only partially fluorinated. Various low molecular weight (up to C14) hydrocarbons (e.g., smokeless paraffin, Isopar™), long-chain (C15 or higher) alkyl petroleum oils or “white oils” (e.g., paraffin oils, linear or branched paraffins, cyclic paraffins, aromatic hydrocarbons to petroleum jelly and wax), and raw or modified vegetable oils and glycerides and combinations thereof can be used. In addition, organosilicone compounds such as linear or branched polydimethylsiloxane (PDMS) (e.g., Momentive Element family silicone lubricants, Siltech silicone lubricants), polydiethylsiloxane (PDES), methyltris(trimethoxysiloxy)silane, phenyl-T-branched polysilsexyquioxane, and copolymers of side-group functionalized polysiloxanes (e.g., Pecosil silicone lubricants) and combinations thereof can be used as a liquid. In some other embodiments, the liquid is an ionic liquid, polyolefins, including polyalpha-olefins (POA), synthetic esters, polyalkylene glycols (PAG), phosphate esters, alkylated naphthalenes (AN), silicate esters or mixtures of any of the above compounds described in this paragraph.

In the various methods of the present disclosure, the cementitious material can be a hydraulic cement material and/or a non-hydraulic cement material including one or more binders as used in the construction industry. Non-limiting examples of types of cements include Portland cement and Portland cement blends, geopolymers, masonry cements energetically modified cement, green cement, sorel cement, cement composites, dental cement, biocompatible cement for bone grafts, ceramic materials and combinations thereof, including inorganic and organic polymers and pozzolan materials.

### BRIEF DESCRIPTION OF THE DRAWINGS

The above and other objects and advantages of the present disclosure will be apparent upon consideration of the following detailed description, taken in conjunction with the accompanying drawings, in which like reference characters refer to like parts throughout.

FIGS. 1A-1C are diagrams illustrating the different between conventional immobilized methods for increasing the service life of a cementitious material by reducing its permeability;

FIG. 2A is a schematic diagram of Slippery Liquid-Infused Porous Surface (SLIPS);

FIG. 2B is a diagram illustrating a mobile Liquid Infused Barrier (LIB) within a porous network and the self-healing nature of the LIB;

FIG. 2C illustrates the filling of a scratch created from a diamond tip on the surface of a cementitious material with liquid from the mobile LIB;

FIG. 2D shows the general steps to alter the wetting properties of cementitious materials to form LIB on PC (LIB-PC) is shown via pathway A where the surface is chemically modified and is then infiltrated with a liquid. Otherwise, unmodified cement displays dynamic wetting (pathway B) when it comes into contact with any liquid;

FIG. 3A-3F illustrates the importance of having the chemical functionalization prior to application of the LIB layer in the SLIPS modified cementitious material;

FIGS. 4A-4D show the microstructure of cementitious materials;

FIGS. 5A-5H show energy dispersive x-ray spectroscopy (EDS) results on chemically functionalized cementitious materials in accordance with certain embodiments;

FIGS. 6A-6C show x-ray photoelectron spectroscopy (XPS) results on chemically functionalized cementitious materials in accordance with certain embodiments;

FIGS. 7A-7F show the wetting behavior before and after the formation of a LIB on cementitious materials in accordance with certain embodiments;

FIGS. 8A-8B show contact angle measurements, contact angle hysteresis measurements, and weight percentage of water as a function of time of heat treatment in accordance with certain embodiments;

FIGS. 9A-9C illustrate the color change due to the liquid infiltration from the bottom up and the presence of the liquid within the structure is confirmed using Fourier transform infrared spectroscopy;

FIGS. 10A-10C show wetting behavior of chemically modified hydrophobic structure and EDS results on samples having improved repellency characteristics in accordance with certain embodiments;

FIGS. 11A and 11B show mechanical properties of the cementitious material having a LIB structure in accordance with certain embodiments;

FIGS. 12A and 12B show the contact angle measurement results after different levels of mechanical abrasion in accordance with certain embodiments;

FIGS. 13A-13D show the schematic illustration for carrying out a freeze-thaw test in accordance with certain embodiments; and the results showing that LIB outperforms untreated samples;

FIGS. 14A-14D show the results of acid resistance testing against 1 wt % HCl, where LIB shows little to no mass loss compared to the control samples; and

FIGS. 15A-15C show the schematic illustration for carrying out a rapid chloride ion permeability test in accordance with certain embodiments.

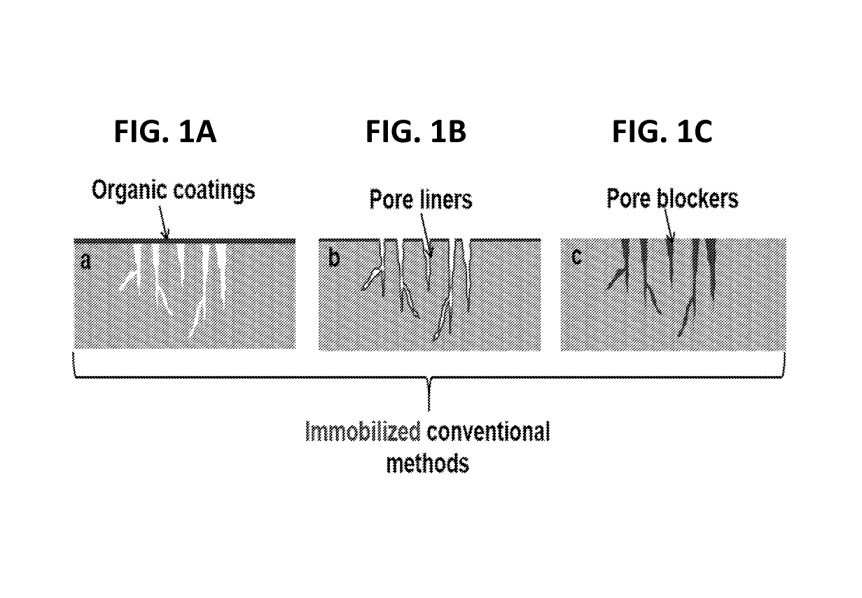

### DETAILED DESCRIPTION

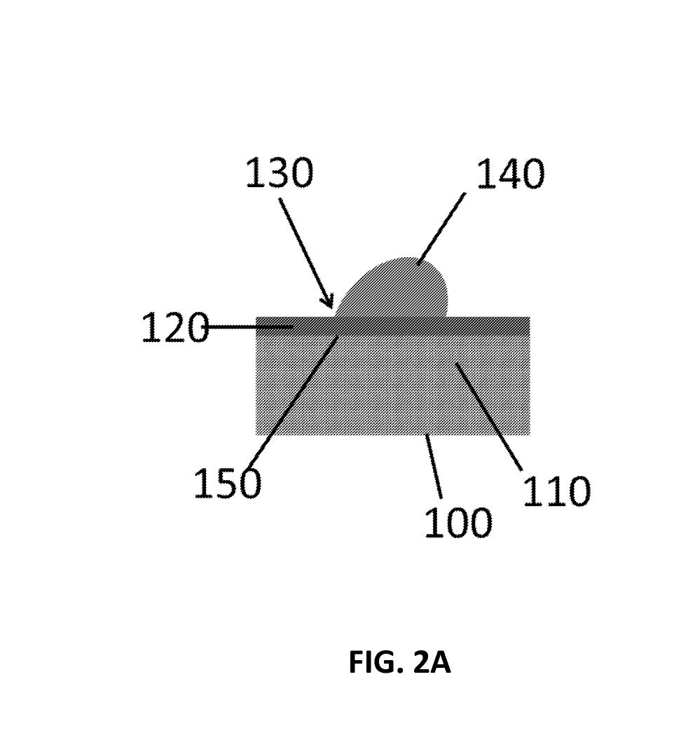

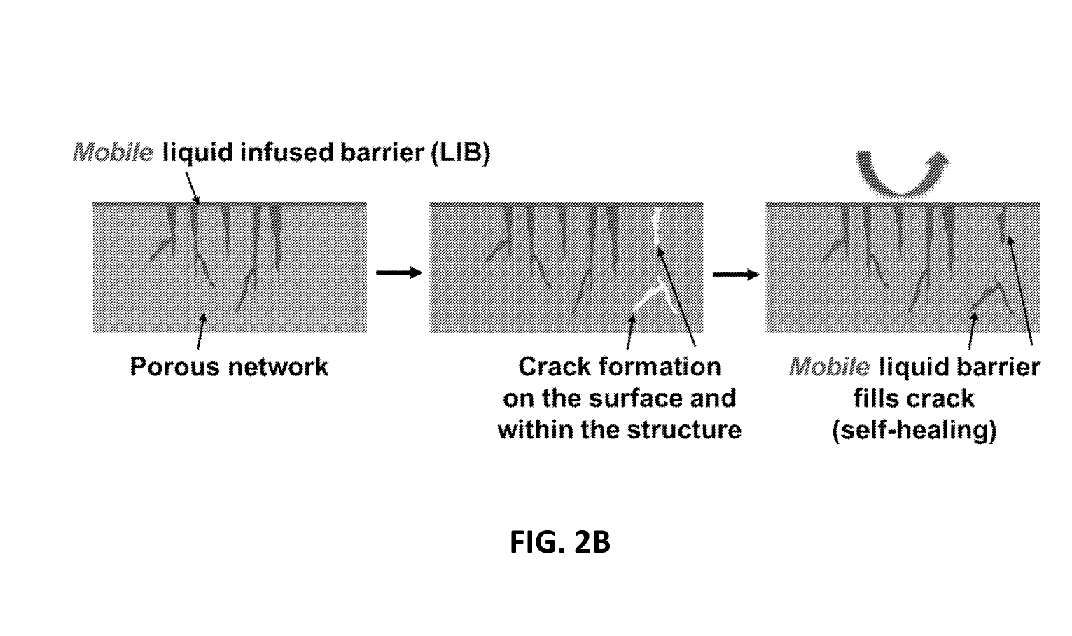

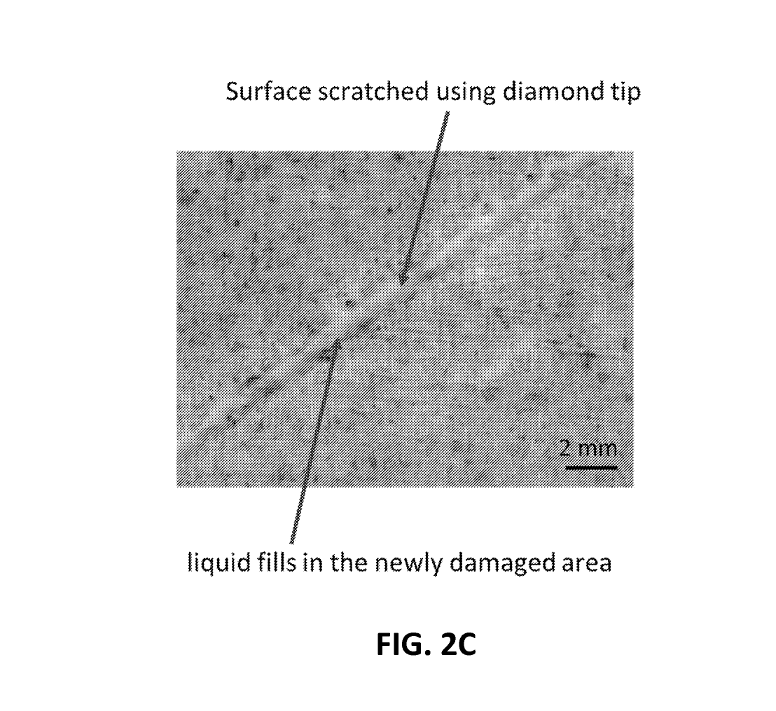

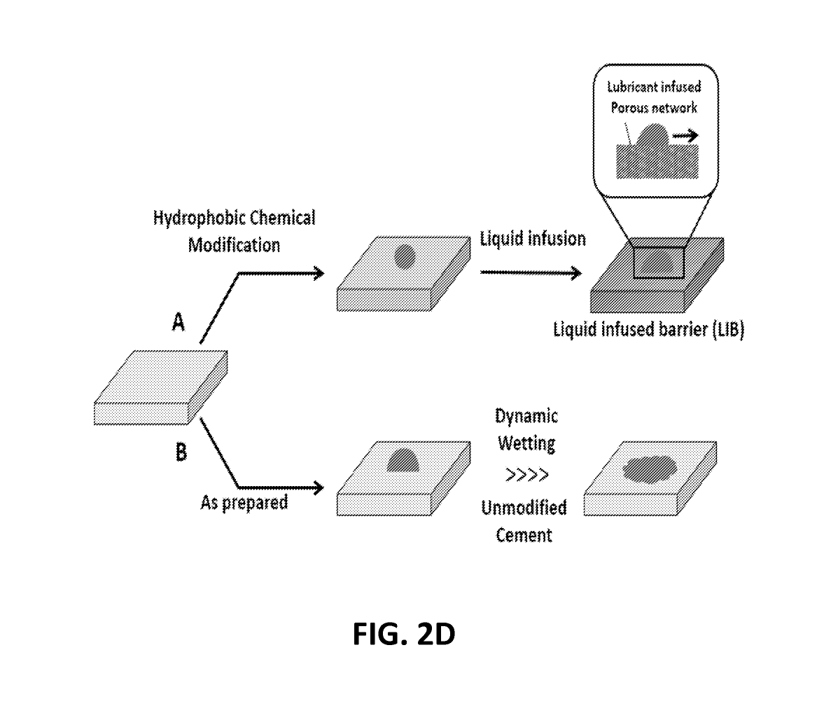

A schematic of the overall design of Slippery Liquid-Infused Porous Surfaces (SLIPS) is illustrated in FIG. 2A. As shown, the article includes a substrate based on cementitious material 100 having a liquid 120 applied thereon. The liquid 120 wets and adheres to the substrate, filling the hills, valleys, and/or pores, and forming a liquid layer over the cementitious material with ultra-smooth surface 130. The liquid layer over the cementitious material is not displaced (or can reform) by the introduction of the foreign object or fluid 140. In certain embodiments, the cementitious materials are functionalized with chemical moieties 150 so that a liquid layer over the cementitious material can be formed thereon without being displaced by foreign objects or fluids and maintain the ultra-smooth surface 130 over the substrate. Accordingly, due to the porous nature of a cementitious material including its internal porosity, a SLIPS associated with a cementitious material inherently forms a LIB or an LIB layer over and within the cementitious material. FIG. 2B is a diagram illustrating a mobile Liquid Infused Barrier (LIB) within a porous network and the self-healing nature of the LIB. As the cracks are formed on the surface or within the structure of the cementitous material, the mobile LIB fills the crack demonstrating the self-healing nature of the LIB. FIG. 2C illustrates the self-healing properties of the LIB layer through the filling of a scratch created from a diamond tip on the surface of a cementitious material with liquid from the mobile LIB.

In certain embodiments, SLIPS includes at least the following three factors: 1) the liquid (Liquid B) can infuse into, wet, and stably adhere within the roughened surface, 2) the roughened surface can be preferentially wetted by the liquid (Liquid B) rather than by the liquid to be repelled (e.g., Object A such as water), and 3) the fluid (Liquid B) and the object or liquid to be repelled (e.g., Object A such as water) are immiscible and do not chemically interact with each other.

Specific details regarding the criteria for SLIPS can be found in U.S. patent application Ser. No. 13/980,856, the contents of which are incorporated by reference herein in its entirety. Moreover, some exemplary materials that can be utilized as the liquid and/or the chemical moieties to functionalize the underlying substrate can be found in U.S. patent application Ser. No. 13/980,856, the contents of which are incorporated by reference herein in its entirety.

Certain exemplary cementitious materials that can be utilized as the substrate include Portland cement, Portland cement blends, geopolymers, masonry cements, energetically modified cement, green cement, sorel cement, cement composites, dental cement, biocompatible cement, and the like. Cement composites can also be utilized, which include any of the materials mentioned above, in combination with inorganic and organic polymers and pozzolanic materials. Examples of pozzolans include but are not limited to fly ash, blast furnace slag and sludge ash. This includes cement materials that contain calcium, aluminum, silicon or iron in elemental or oxidized states.

Cementitious samples can be modified to achieve desired properties by dipping samples in solution, electrochemical modification, physical vapor deposition, chemical vapor deposition, atomic layer deposition, deposition by plasma, thermal evaporation, ion bombardment, functionalization via spraying of modifying agent, and other common surface modification methods known in the art.

The lubricant can be infiltrated by soaking, painting, spray coating, printing, suctioning, natural convection and can be accelerated by addition of heat, pressure or vacuum, centrifugal force, or mechanical agitation.

### Challenges in Forming SLIPS Using Cementitious Materials

While the presence of pores in cementitious materials may be advantageous for forming SLIPS structures, use of cementitious materials as substrates for SLIPS provided significant challenges.

For instance, in the formation of cementitious materials, the presence of water is important. Slow evaporation of water during cementitious material formation prevents shrinkage and crack propagation, where excess amount of cracks can lead to poor mechanical integrity. As such, formation is carried out in the presence of water and conditions are provided to reduce the evaporation of water away from the cementitious material. However, the water is retained within the cementitious material after formation and pose significant challenges in generating SLIPS structures.

Moreover, the hydrophilic nature of cementitious materials facilitates significant capillary adsorption of water onto pore walls even at relative humidity levels of below 45%. The water strongly adheres within the pores and this adsorption of water leads to the formation of a highly viscous thin film that was difficult for other compounds to displace or penetrate.

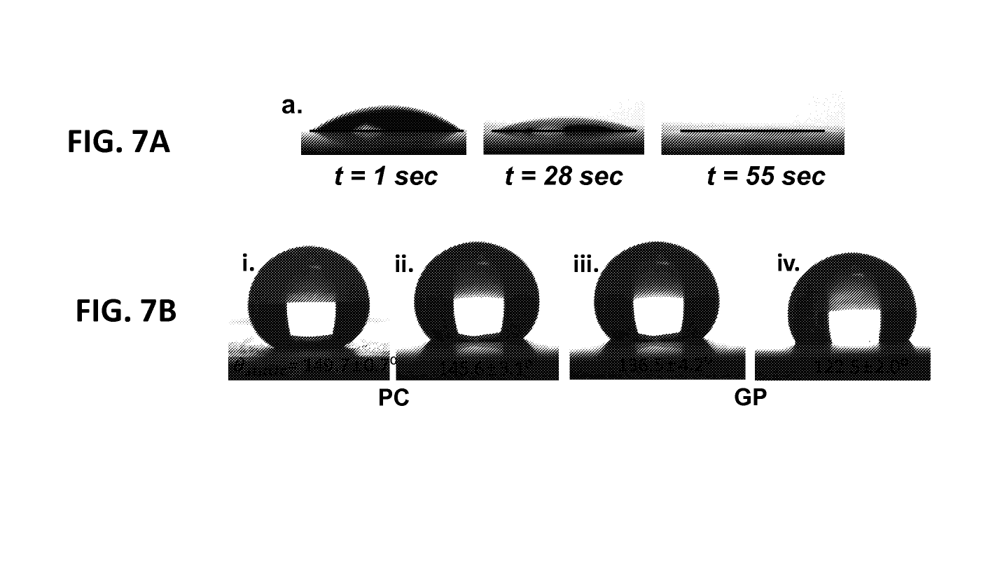

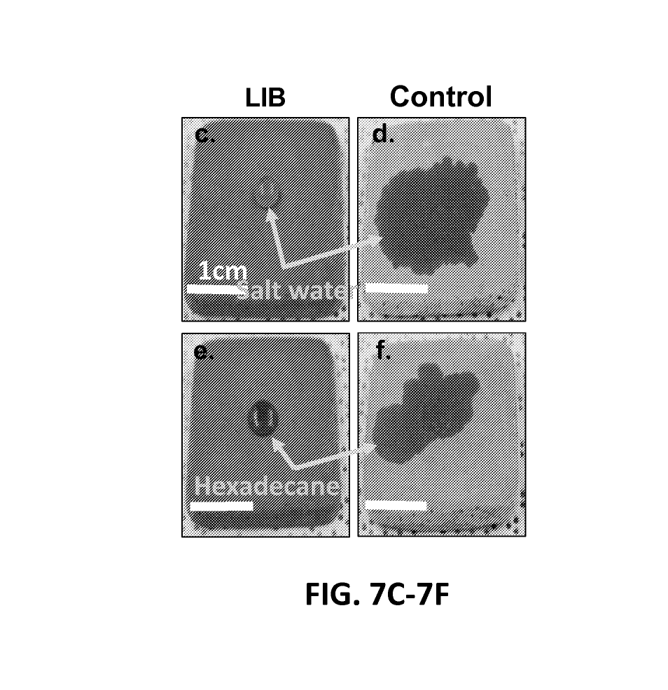

Accordingly, as shown in FIG. 7 described in more details later in this disclosure, water droplets can become adsorbed and/or absorbed into the cementitious material. In FIG. 7A, the surface is initially dynamically wetting in state 1 (i.e., tₒ=the moment the droplet was applied (e.g., 1 sec)) where in a time scale of, tₒ<t<t (e.g., 55 sec), the water droplet is gradually absorbed into the surface.

In one aspect, in order to obtain reliable repellent characteristics associated with a liquid infused barrier structures, one or more pretreatments of the cementitious material can be carried out. In order to overcome the unique challenges posed by cementitious materials in forming SLIPS, at least the following pretreatment is provided to the cementitious material: (1) heat treatment; (2) surface removal (i.e. removal of the skin layer); and (3) combination thereof. Thereafter, the cementitious material can be functionalized with materials that provide enhanced affinity with the liquid so that a liquid layer over the cementitious material can be formed thereon without being displaced by foreign objects or fluids.

In one embodiment, the wetting properties of a cementitious material is modified using hydrophobic chemical modification, as shown in pathway A of FIG. 2D. Pathway A shows the chemical functionalization of the cementitious material followed by infiltration of the chemically functionalized cementitious material with a liquid, which can prevent the dynamic wetting behavior shown in FIG. 7A. After the successful application of a liquid infused barrier, the water droplet is still not absorbed and remains as a droplet on the surface even for t>t (e.g., 55 sec) as shown in FIG. 7B.

### Pretreatment: Removal of Water

In certain embodiments, after the formation of the cementitious materials, the cementitious material is treated to remove water that may be adsorbed and/or absorbed within the pores and bulk of the cementitious material. In certain embodiments, the temperature can controlled to provide sufficient kinetics to drive off the adsorbed water but should not be too high to lead to damages (e.g., cracking) within the cementitious structure that can be induced by thermal stresses. The time taken to remove the water may depend on the temperature of treatment. For example, increased temperatures can lead to shorter treatment times, while lower temperatures can lead to longer treatment times. In one embodiment, the cementitious materials is baked at a temperature between 60° C. and 70° C. for about 3-5 hours. For example, a temperature range between 24° C. and 50° C. for about 48 hours may be utilized.

In certain embodiments, rather than heating the entire structure, only the top surface of the cementitious material can be exposed to a high heat source, such as a flame torch or heat gun, to drive off the water that have been adsorbed near the top surface of the cementitious material. In such instances, applied heat can be at a temperature greater than 400° C., 200-400° C., 100-200° C., 40-100° C., or room temperature −40° C. depending on the method of applying heat. Moreover, the exposure to the heat can be limited to be below 3 s, 3-30 s, 30-60 s, 1 min-10 min, 10 min-60 min, 1-2 h, or >2 h depending on the temperature. In certain embodiments, while each exposure may be short lived, the surface can be repeatedly exposed to the heat but in short bursts such that the adsorbed water is driven off but the cementitious material is not significantly thermally stressed to generate cracks therein.

In certain embodiments, the treatment can be carried out so that at least—100 μm thick layer of the cementitious material's surface becomes substantially free of adsorbed water before functionalization is carried out. In certain embodiments, the heat treatment is carried out so that there is approximately 10-50 μm, 100-200 μm, 200-500 μm, or 500-1000 μm thick layer of the cementitious material's from the surface becomes substantially free of adsorbed and/or absorbed water before functionalization is carried out.

### Pretreatment: Top Surface Removal

In certain embodiments, during formation of the cementitious material, certain localized regions on the top surface of the cementitious material may develop elevated concentrations of ionic species as compared with the surrounding regions. These regions may have a size scale of about 10 μm or greater. Such localized regions of elevated concentrations of ionic species may substantially hinder the formation of a liquid layer over the cementitious material. For instance, it was observed that even if the liquid forms an overlayer over such regions, when a foreign object or fluid comes in contact with the liquid, the liquid may become displaced and the foreign object or fluid can become pinned to the underlying cementitious material's surface.

Surprisingly, however, it was found that with only the removal of 100 μm thick layer from the top surface of the cementitious material, the size of such localized regions of elevated concentration of ionic species is substantially reduced. In some instances, removal of the top surface of the cementitious material can be carried out until the newly exposed surface of the cementitious material contains localized regions of elevated concentration of ionic species that are smaller than 10 μm in size. For example, removal of the top surface of the cementitious material can be carried out until the newly exposed top surface of the cementitious material contains localized regions of elevated concentration of ionic species that are approximately 10 μm or less in size. These areas can be detected using energy dispersive spectroscopy techniques.

In certain embodiments, removal of the top surface of the cementitious material also increases the roughness of the cementitious material and allows access to the pores beneath the top surface. For example, roughness factor, R, can be increased by about 2, about 3, about 5, or about 10 times by removal of the top surface of the cementitious material. The increased roughness further promotes stable immobilization of the liquid to form a liquid layer over the cementitious material.

Many different removal techniques can be utilized, such as grinding, sanding, sand blasting, cutting, polishing and the like. In certain embodiments, removal of the top surface is carried out in a manner such that the pores of the cementitious material do not become plugged and the cementitious materials do not lose their porosity. In certain embodiments, removal of the top surface is carried out so that the newly exposed top surface has a roughness factor, R, that is greater than 1. In certain embodiments, the removal process does not introduce cracks that are larger than 10 μm that can lead to degradation in mechanical properties.

In certain embodiments, one or more of the above-described pretreatment processes can be carried out and in any desired order of operation. For example, in certain embodiments, only top surface removal pretreatment can be carried out. In other embodiments, only a treatment to remove water using, for example, heat can be carried out. In certain embodiments, top surface removal can be followed by heat treatment or vice versa. Other combinations of treatment steps to further promote the formation of a liquid layer over the cementitious material will be apparent to one skilled in the art.

### Chemical Functionalization of Pretreated Cementitious Materials

In certain embodiments, the pretreated cementitious material can be chemically functionalized with certain chemical moieties that provide low surface energy coatings to promote stable immobilization of the liquid within the pores of the cementitious materials. In certain embodiments, the chemical moieties may be bound to the surface of the cementitious material. In certain embodiments, the chemical moieties may provide fluorinated or perfluorinated functional groups, such as —CF₃, —CF₂H, —CF₂—, —CF₂—CF₃, —CF₂—CFH—, —CF₂—CH₂—, —CFH—CH₂— and the like.

Some exemplary materials that can be utilized to chemically treat the cementitious materials include perfluoroalkyl phosphate molecules (FS), octadecylphosphonic acid molecules, perfluoroalkyl, alkyl, silicone, perfluorether, phosphonate, fluorocarbons, silanes and any combinations of the above, and the like. Functionalized silanes are common reactants with which to modify the chemical nature of the cementitious material. Surface functionalization also can be achieved using appropriately functionalized phosphonic acids, e.g., 1H,1H,2H,2H-tridecafluorooctylphosphonic acid, phosphates, carboxylic acids, sulfonic acids, and similar organic/inorganic acids and their respective mono- or di-esters with appropriate linkers and end functional groups, e.g. oligo-silicone or alkyl terminated with a phosphate group. Examples of other surface modifiers include, but are not limited to, long-chain alkyl carboxylic acids, perfluorinated carboxylic acids (e.g., perfluorooctadecanoic acid and other homologues), alkyl or fluorinated phosphonic, phosphinic, phosphoric, and sulfonic acids, alkyl or fluorinated silanes, end-functionalized alkyl or fluorinated polymers, such as DuPont Krytox™ series of surfactants (like Krytox™ 157 FSL, FSM, FSH), silicone oligomers with modified end groups including carboxylic, phosphonic, phosphinic, phosphoric, sulfonic acids and silanes, and combinations thereof. The chains of the surface modifier molecules can be linear or branched and they can be partially fluorinated. The solution or vapor phase chemical treatment can be done at a desired temperature depending on the reactivities and other properties of the modifying molecules and surfaces to be modified. A variety of solvents of different solubilizing properties, volatilities and boiling points can be used for the surface modifications. In addition to simple immersing, the solution modification can be done by exposing the surface to refluxing the solution of the modifier, or by continuously spraying it onto the surface, or pumping/recirculating the solution through the pipe whose surface needs to be modified, or any other appropriate way of bringing the surface and the modifier solution in contact. The treatment may be carried out at higher temperatures (70° C.-100° C.) to increase the modification kinetics.

In certain embodiment, the cementitious material can be treated with a plasma to chemically functionalize the cementitious material. For example, plasma treatment using low surface energy molecules, such as fluorocarbons, paraffins, wax, silicones, organosilanes with low surface energy organic groups and the like, can be carried out.

### Formation of SLIPS Surfaces Over Chemically Functionalized Cementitious Materials

After the cementitious materials have been chemically functionalized, liquid can be provided that forms a liquid layer over the cementitious material.

Certain exemplary liquids that can be utilized include fluorinated liquids (such as Krytox™ PFPE (DuPont, perfluoropolyether), fluorinated oils, silicone oils, mineral oils, and the like), perfluoroalkylamines (such as perfluorotri-n-pentylamine, FC-70 by 3M, perfluorotri-n-butylamine FC-40, and the like), perfluoroalkylsulfides and perfluoroalkylsulfoxides, perfluoroalkylethers, perfluorocycloethers (such as FC-77) and perfluoropolyethers (such as Krytox™ family of lubricants by DuPont, Fomblin™ family of lubricants by Solvay), perfluoroalkylphosphines and perfluoroalkylphosphine oxides as well as their mixtures can be used for these applications, as well as their mixtures with perfluorocarbons and any and all members of the classes mentioned. In addition, long-chain perfluorinated carboxylic acids (e.g., perfluorooctadecanoic acid and other homologues), fluorinated phosphonic and sulfonic acids, fluorinated silanes, and combinations thereof can be used as liquid. The perfluoroalkyl group in these compounds could be linear or branched and some or all linear and branched groups can be only partially fluorinated. In addition, organosilicone compounds such as linear or branched polydimethylsiloxane (PDMS) (e.g., Momentive Element family silicone lubricants, Siltech silicone lubricants), polydiethylsiloxane (PDES), methyltris(trimethoxysiloxy)silane, phenyl-T-branched polysilsexyquioxane, and copolymers of side-group functionalized polysiloxanes (e.g. Pecosil silicone lubricants) and combinations thereof can be used as Liquid B. In addition, various low molecular weight (up to C14) hydrocarbons (e.g. smokeless paraffin, Isopar™), long-chain (C15 or higher) alkyl petroleum oils or “white oils” (e.g. paraffin oils, linear or branched paraffins, cyclic paraffins, hydrocarbons to petroleum jelly and wax), and raw or modified vegetable oils and glycerides and combinations thereof can be used as a liquid, for example, as a liquid infiltrating barrier.

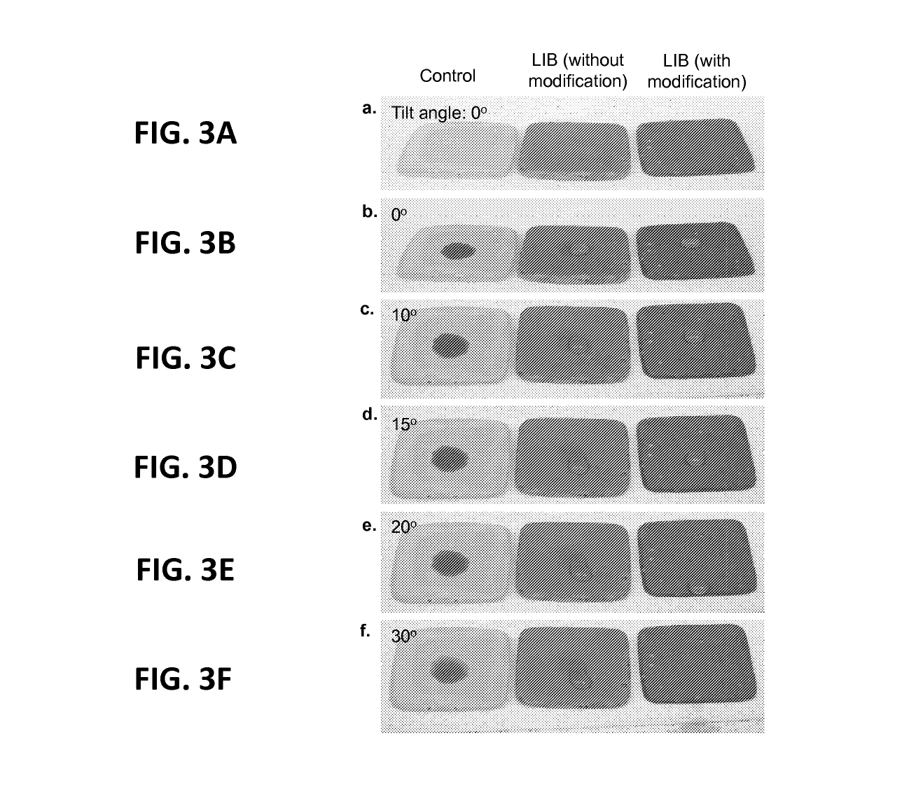

FIG. 3A-3F illustrates the importance of having the chemical functionalization prior to application of the LIB layer in the SLIPS modified cementitious material. FIG. 3A shows images of samples of untreated cementitious material (control, on the left), a SLIPS modified cementitious material with no chemical functionalization (SLIPS (without modification), in the center), and a SLIPS modified cementitious material with chemical functionalization to (SLIPS (with modification), on the right) that are placed flat on a surface at 0° before exposure to dyed water. FIG. 3B shows images of samples of untreated cementitious material (control, on the left), a SLIPS modified cementitious material with no chemical functionalization (SLIPS (without modification), in the center), and a SLIPS modified cementitious material with chemical functionalization (SLIPS (with modification), on the right) that are placed flat on a surface at 0° after exposure to dyed water. The untreated cementitious material absorbs the dyed water droplet immediately which completely wets the cementitious material. In contrast, the dyed water droplet forms a bead on the sample in the center and the right. FIG. 3C, FIG. 3D, FIG. 3E, and FIG. 3F show images of samples of untreated cementitious material (control, on the left), a SLIPS modified cementitious material with no chemical functionalization (SLIPS (without modification), in the center), and a SLIPS modified cementitious material with chemical functionalization (SLIPS (with modification), on the right) that are at an angle of 10°, 15°, 20°, and 30° with the flat surface, respectively, after exposure to dyed water. There is no change in the control untreated sample on the left since the dyed water droplet has already been absorbed. However, the samples in the center in FIG. 3C-3F, i.e., the cementitious material modified with SLIPS without chemical functionalization show that although the dyed water droplet forms a bead and roll off as the tilt angle is increased, it can quickly penetrate the liquid overlayer by displacing the lubricant and stain the cementitious material. In contrast, the samples in the right in FIG. 3C-3F, i.e., the cementitious material modified with SLIPS with chemical functionalization show that the dyed water droplet forms a bead which is unable to penetrate the liquid overlayer and stain the cementitious material. Without wishing to be bound by theory, this behavior may be attributed to the presence of the chemical functionalization of the surface of the cementitious material that keeps the liquid overlayer in place and immobilizes it.

### EXAMPLES

### Geopolymer Synthesis

Metakaolin (Metastar 402), fumed silica (Cabosil-M5), sodium hydroxide (Sigma Aldrich, reagent grade) were used as received. The composition of the metakaolin was determined as 2.15.SiO₂.Al₂O₃ using X-ray fluorescence. Alkaline silicate solutions were prepared by dissolving fumed silica in sodium hydroxide solutions with composition of SiO2/Na20=1.5 at 40° C. Sodium hydroxide solutions were prepared by dissolving NaOH pellets in deionized water with composition of H₂O/Na₂O=11.

Geopolymers were synthesized by mechanically mixing metakaolin with alkaline silicate solutions in stoichiometric ratio of Al₂O₃/Na₂O=1, using a planetary mixer for 60 s at 2000 rpm for mixing and then another 60 s at 2200 rpm for defoaming. The slurries were cast into silicone molds and sealed. The samples were then left to cure at 40° C. and ambient pressure for 20 h.

### Portland Cement Synthesis

General type I/II general PC (Ashgrove Cement Company) paste solutions were prepared in water with a water to cement (w/c) ratio of 0.4375. The pastes were mechanically mixed using a planetary mixer for 180 s at 600 rpm. Specimens were cast and sealed in silicone molds. They were cured at 40° C. and ambient pressure for 24 h.

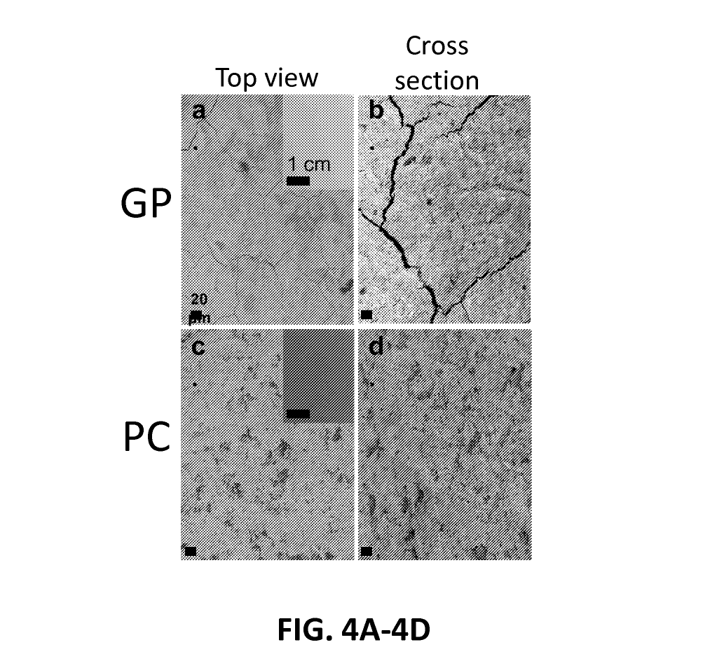

As shown in FIGS. 4A-4D, both GP (geopolymers) and PC (Portland cements) have similar inherent microstructure features on the surface (FIGS. 4A and 4C) as well as in the bulk (FIGS. 4B and 4D).

### Comparative Example 1

Formation of SLIPS structures was attempted without any pretreatment or chemical functionalization of the cementitious materials. Here, GP and PC was formed as described above. Then, without any of the pretreatment steps described herein, different liquids, such as a silicone oil and a fluorinated lubricant KRYTOX PFPE (DuPont, perfluoropolyether), were applied to the cementitious material, some even as long as about 48 hours. However, SLIPS structures having a liquid layer over the cementitious material was not achieved.

Cementitious materials have an amorphous structure with varying porosity. As a result the surfaces are highly absorbent and display dynamic wetting properties; such that liquids of varying properties are readily absorbed. It was shown that both GP and PC can initially absorb hydrophobic liquids. However, these liquids can be easily displaced by a hydrophilic liquid, possibly due to the inherently hydrophilic nature of cementitious materials.

This was also observed when fluorinated lubricant, Krytox PFPE (DuPont, perfluoropolyether) and silicone oil (Momentive 10A) were readily absorbed by both GP and PC. However, in both cases the lubricant was easily displaced when contacted with hydrophilic liquids such as water. Thus, infiltration of lubricant into the cementitious material alone without any pretreatment and chemical functionalization was not sufficient.

### Comparative Example 2

One method to achieve stable SLIPS was to decrease the surface energy of the substrate by chemical functionalization. The samples were chemically functionalized right after the curing process (saturated with water). A phosphate ester of two long chain perfluoroalkyl (FS) was purchased from Mason Surfactant. All solutions were prepared using reagent grade ethanol. All of the commercially available chemicals were used without any further functionalization.

In this case, it was observed that after treating samples in a perfluoroalkyl phosphate surfactant (FS) solution the stability of the lubricant-substrate interface can be increased, where the perfluoroalkyl phosphate surfactant molecule was shown to bond generally well to metal oxides that are present in high contents in both PC and GP.

After chemical functionalization, it was observed that the surfaces of GP and PC were no longer dynamically wetting when contacted with water. However, these super hydrophobic samples had limited repellency to only water, and failed when contacted with liquids with low surface tension liquids.

The samples were then lubricated with Krytox GPL 100 (K100) (Dupont Chemicals) perfluoropolyether (PFPE). The lubricant was dispensed on the surface of the samples and was allowed to spread and be absorbed. Full lubrication and reaching an equilibrium took approximately 72 h, which was indicated by a color change of the surface and the presence of excess lubricant on the surface. The color of the entire sample changed from a lighter shade to a darker shade when the lubricant was fully infiltrated.

After lubrication it was observed that the GP and PC samples were able to repel certain solvents such as ethanol and acetone in addition to water. However, repellency of the solvents from the cement samples was observed to be inhomogeneous, where samples eventually became wetted by the solvent in various, unpredictable regions.

Without wishing to be bound by theory, it was hypothesized that this is attributed to the high water content present in the freshly cured samples. Using TGA, as-prepared GP and PC samples were found to contain 91.4±2.8% and 90.8±2.4% of water by mass, respectively.

Generally, the presence of residual water in cementitious systems is important. Slow evaporation of water prevents shrinkage and crack propagation. However, the presence of residual water in this case, decreases the kinetics of the chemical functionalization. The problem may be caused by the hydrophilic nature of cementitious materials, which can facilitate significant capillary adsorption of water onto pore walls at relative humidity below 45%. Above this, the rate of adsorption may be reduced because the number of available sites for water vapour becomes limited. The rate of adsorption depends on the local surface energy at any point along the wall and the presence of unsaturated surfaces. This multi-layer adsorption leads to the formation of a highly viscous thin film that was difficult for other compounds to easily displace or penetrate. As a result, the remaining water may create a stable hydrated form on the surface of the cement materials and thus making the surfaces less favorable to chemical functionalization.

### Example 1

### Removal of Water

After the cementitious samples were cured as described above and before the chemical functionalization of the samples, residual water was removed from GP and PC samples by applying a heat treatment method at 70° C.

The samples were then chemically functionalized. A phosphate ester of two long chain perfluoroalkyl (FS) was purchased from Mason Surfactant. All solutions were using reagent grade ethanol. All of the commercially available chemicals were used without any further modification.

The GP and PC samples were functionalized in a 1 wt % FS solution in 95/5 v/v ethanol/water for 12 h at 70° C. and were then transferred into ethanol at 70° C. for 10 min. The samples were then dried for 1-2 h at 70° C. to remove ethanol from the chemically functionalized sample.

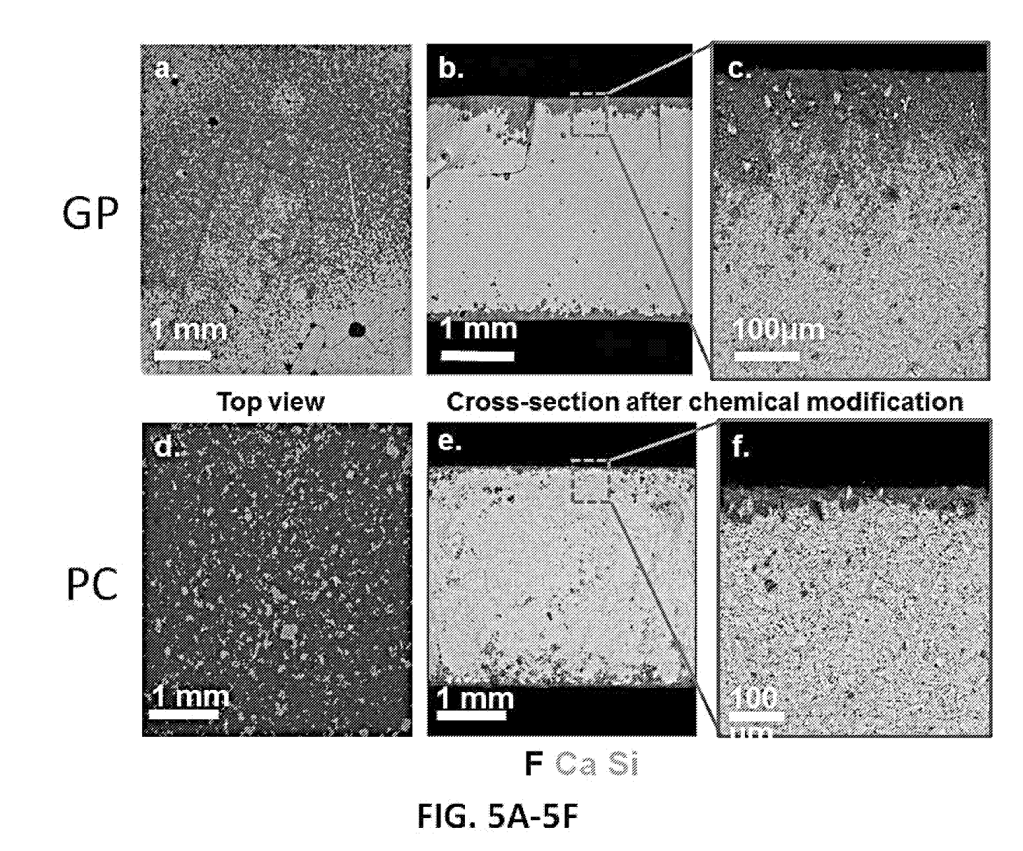

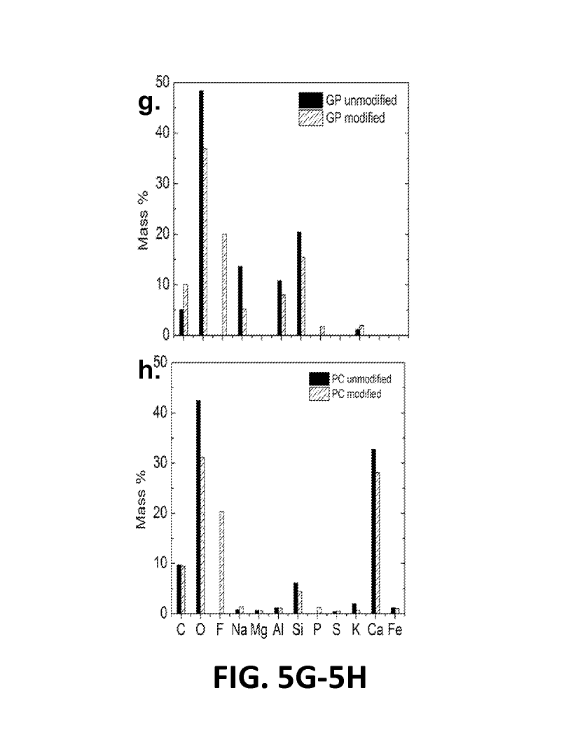

The samples were then analyzed to determine the distribution of chemically bound FS on the surface and within the bulk material using x-ray photoelectron spectroscopy (XPS) and energy dispersive x-ray spectroscopy (EDS) mapping. FIGS. 5A-5H show EDS results on both the surface and cross section of GP (FIGS. 5A-5C) and PC (FIGS. 5D and 5F). In both cases it was observed that the fluorine concentrated on surface rather than dispersed throughout the entire network as the concentration of FS present on the surface was much greater than that present within the bulk of the material, for both GP and PC. The scattered presence of fluorine atoms in the EDS map on the inner areas of the cross section indicate that there are some percolation pathways present that allow for the FS molecule to penetrate through the bulk material and diffuse through. These percolation pathways are assumed to be a combination of the inherent porosity and micro-cracks that could potentially be present within the cementitious materials.

Moreover, the relative distribution of the elemental composition (see FIGS. 5G and 5H) shows that inherently both GP and PC do not contain fluorine or phosphorous and after chemical functionalization both have similar ratios.

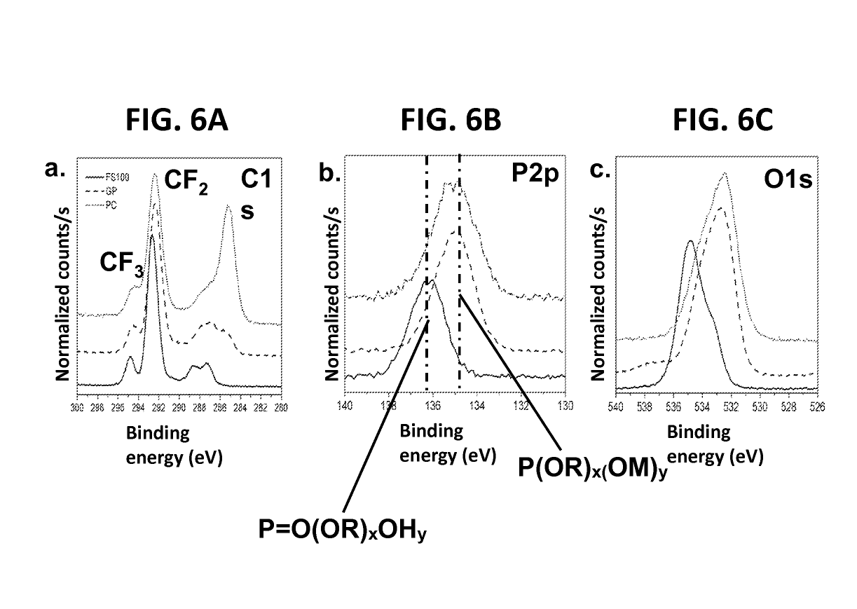

FIGS. 6A-6C show the XPS spectra that was obtained. XPS spectra obtained shows that there are FS molecules present on the surface that are not only physically adsorbed but also chemically bound to the surface. High resolution scans of selective peaks are shown in FIGS. 6A-6C and the binding energies of elements present in pure, unbound FS molecules as well as those that are on GP and PC after the attempted chemical functionalization are compared. The spectra obtained confirm the presence of CF₂ and CF₃ on the surface. In addition, there is a peak shift in the P2p and O1s which indicates that the FS molecules are covalently bound to the surface and not only physically adsorbed.

The wetting properties of such samples were measured. Water contact angle was measured using 8 μL water droplets. The minimum heat treatment time for both GP and PC was determined by choosing the condition that yields the highest water contact angle (CA) after chemical functionalization (but before lubrication) and the lowest contact angle hysteresis (CAH) after lubrication. A high static water CA indicates that chemical functionalization of the surface was sufficient to maintain hydrophobic wetting properties. Also, it shows that the solid-lubricant interfacial energy was minimized and is favorable compared to the solid-water interaction.

First, as a control, the contact angle on unmodified samples were measured (i.e., without any heat treatment or chemical functionalization). However, the water contact angle could not be quantitatively measured due to fast dynamic wetting taking place as soon as the droplet was placed on the sample. FIG. 7A shows qualitatively how the water droplet spreads out and becomes completely absorbed into the cementitious material in less than a minute. Likely, dynamic wetting occurs due to the inherently hydrophilicity and high porosity of the cementitious material.

FIG. 7B shows the contact angle measurement images after chemical functionalization (FIGS. 7B (i) and 7B(iii) for GP and PC, respectively) and lubrication with an LIB layer (FIGS. 7B(ii) and 7B(iv) for GP and PC, respectively. As shown, surfaces display hydrophobicity with little to no indication of the presence of dynamic wetting. However, after chemical functionalization (and without lubrication), even though the water CA was high, the droplets were mostly in the Wenzel wetting state (i.e., pinned droplets at tilt angle of 90°). This behavior is attributed to the inherent heterogeneous porosity of the cement materials. In contrast, after lubrication, the droplets easily rolled off the surfaces. Therefore, even though both GP and PC can be rendered highly hydrophobic by chemical functionalization, there are still remaining drawbacks associated with the pinning of water droplets for practical applications and infiltration of the liquid to form a liquid layer over the cementitious material provides greater benefits.

Cementitious surfaces modified by SLIPS were able to develop omni-phobic properties i.e., they were able to repel a variety of liquids. FIGS. 7C and 7D show a cementitious surface modified by SLIPS and an unmodified control upon which 50 μl of salt water was dispensed. Similarly, FIGS. 7E and 7F show a cementitious surface modified by SLIPS and an unmodified control upon which 50 μl of hexadecane was dispensed. In both instances, the surface modified with SLIPS demonstrates beading of the droplet whereas the dispensed liquid is absorbed into the surface of the cementitious surface of the control. Additionally, the sliding angle for cementitious surface, such as PC, modified by SLIPS were measured for liquids with different surface tensions. These results are summarized in Table 1 below.

TABLE 1
sliding angle for SLIPS modified cementitious surface,
such as PC, with liquids of various surface tensions.

| | Surface Tension (mN/m) @ | |
|---|---|---|
| Liquid | 20° C. | Sliding angle (°) |
| Hexadecane | 20.27 | 13.8 ± 3.6 |
| Ethanol | 22.1 | 13.4 ± 3.2 |
| Salt water | 72.8 | 10.0 ± 2.1 |

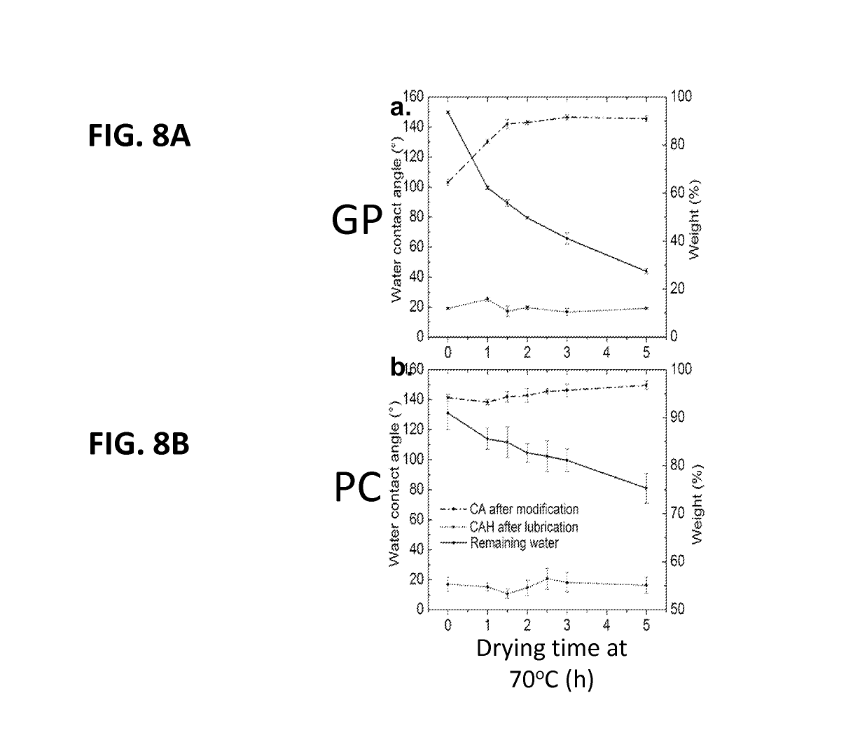

As shown in FIGS. 8A and 8B, the result of the length of time of heat treatment on the resulting wetting properties were also studied for both GP and PC, respectively. As shown in FIG. 8A, we found that the presence of residual water within the GP samples greatly reduced the ability to chemically functionalize the cementitious material and that contact angle reaches a plateau of about 145° after about 1.5 hours. However, as shown in FIG. 8B, heat treatment of PC did not exhibit such dependence. Therefore the heat treatment on GP significantly affected the outcome of the wetting properties while it was not necessary for PC.

Table 2 below summarizes the change in the contact angle that was measured using no or 5 hours of heat treatment prior to chemical functionalization of the cementitious material.

TABLE 2
Water contact angles of cement samples.

| | | After heat treatment | |
|---|---|---|---|
| | | at 70° C. | |
| Cement Type | As prepared samples | 0 h | 5 h |
| Geopolymer | dynamically wetting | 103.1 ± 2.0° | 145.6 ± 1.9° |
| Portland cement | dynamically wetting | 141.3 ± 2.3° | 149.7 ± 2.8° |

Moreover, it was observed that heat treatment greater than 6 h usually led to formation of cracks and loss of mechanical stability, but heat treatments less than 6 hours provided little loss of mechanical stability.

In the case of PC where additional heat treatment is not required, drying at lower temperatures (<50° C.), but still above room temperature helps not only remove some water but also increase the mechanical properties of cement, because they would naturally gain strength over time.

Similar results to those shown in Table 2 were also achieved by allowing the GP and PC to dry at room temperature and ambient pressure for 48 h.

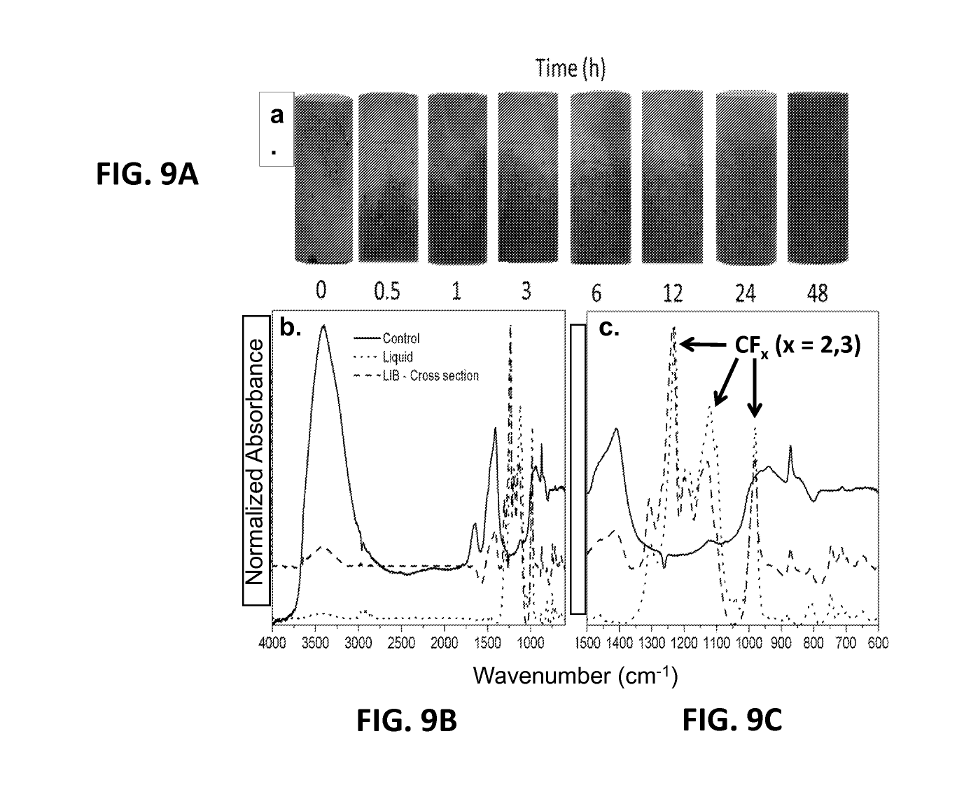

The samples that were chemically functionalized were then lubricated with Krytox GPL 100 (K100) (Dupont Chemicals) perfluoropolyether (PFPE). The lubricant was dispensed on the surface of the samples and was allowed to spread and be absorbed. Full lubrication and reaching an equilibrium took approximately 72 h depending on the sample size, which was indicated by a color change of the surface and the presence of an overlayer of lubricant on the surface. The color of the entire sample changed from a lighter shade to a darker shade when the lubricant was fully infiltrated. The presence of the lubricant within the structure was confirmed using Fourier transform infrared spectroscopy (see FIGS. 9A-9C).

### Example 2

### Top Surface Layer Removal

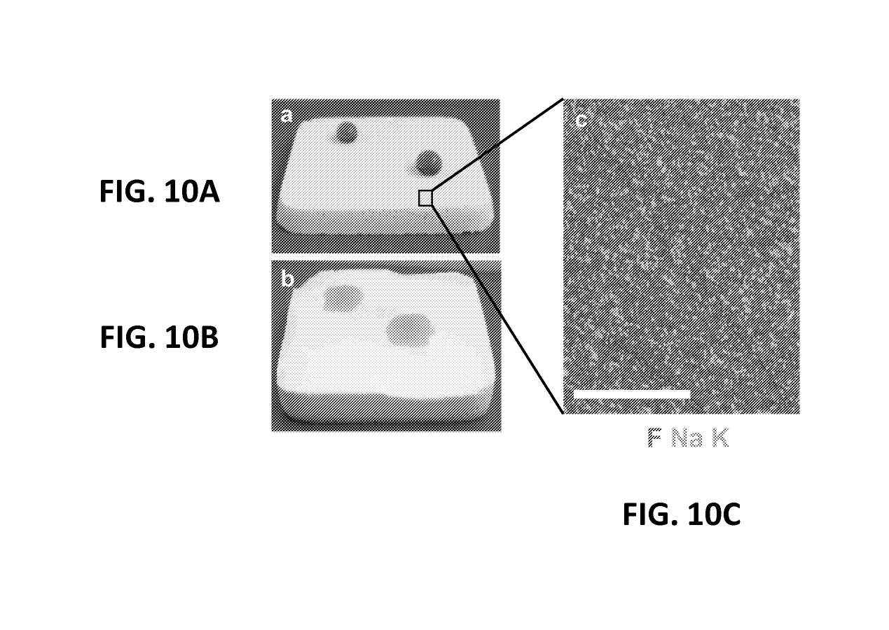

Occasionally, it was observed that only a certain number of samples achieved desired wetting properties while others displayed dynamic wetting properties, as seen in FIGS. 10A and 10B. On the same sample that was heat treated as discussed above in Example 1, some sample maintained the high repellency, while some samples lost the repellency and became wetted. This observation was more prominent in GP samples rather than PC samples. It was hypothesized that there is the formation of a skin layer on GP that is very smooth and contains an increased amount of ionic species compared to the bulk. Thus, the surface of the GP samples were wet-dry polished using small aluminosilicate grit.

The surfaces of both GP and PC were abraded using wet/dry polisher to remove the any skin layer. A low speed and grit size were used to abrade away approximately 1 mm thick layer of the surface. With these additional steps, the functionalization of the cementitious material was consistent and reliable, and it was observed that the percent of samples modified with desired stable wetting characteristics increased.

As discussed above with respect to FIGS. 5A-5D, EDS mapping shows that the concentration of fluorine on the surface was greater than that of the bulk. The heterogeneous distribution of fluorine on the surface of the sample (FIGS. 5A and 5D) was hypothesized to be associated with the initial elemental composition of the surfaces. It was observed that fluorine was mostly not found in the same areas as cations such as sodium and potassium were found. This is shown in FIG. 10C where the potassium does not co-localize with the fluorine. There is some co-localization between sodium and fluorine but it should be noted that this method mostly provides qualitative assessment of the chemical functionalization. Therefore the areas of concentrated ionic species become defective areas where pinning of liquid can occur.

After the removal of the top layer, the samples were lubricated, and the amount of pinning that occurs on the surface was significantly reduced. Without wishing to be bound by theory, the presence of small localized areas of ionic species may not jeopardize the slippery properties of the surface if the length scale of the defective domains is small enough to still provide a lubricant overlayer across the defect. Thus, from qualitative observation the chemical defects are small enough such that the surface displays slippery properties.

### Example 3

### Other Chemical Functionalization

In addition to chemical functionalization using FS, other surface functionalization methods were explored as well. The samples were treated with C₄F₈ plasma for 8 seconds using an inductively coupled plasma reactive ion etching (ICP-RIE) system. They were also treated in 1 wt % octadecylphosphonic acid solution in 95/5 v/v ethanol/water using the same procedure for FS solution. These samples were also lubricated using mineral oil and silicone oil and similar results were observed where the surfaces were able to repel liquids with a wide range of surface tensions.

### Example 4

### Mechanical Properties

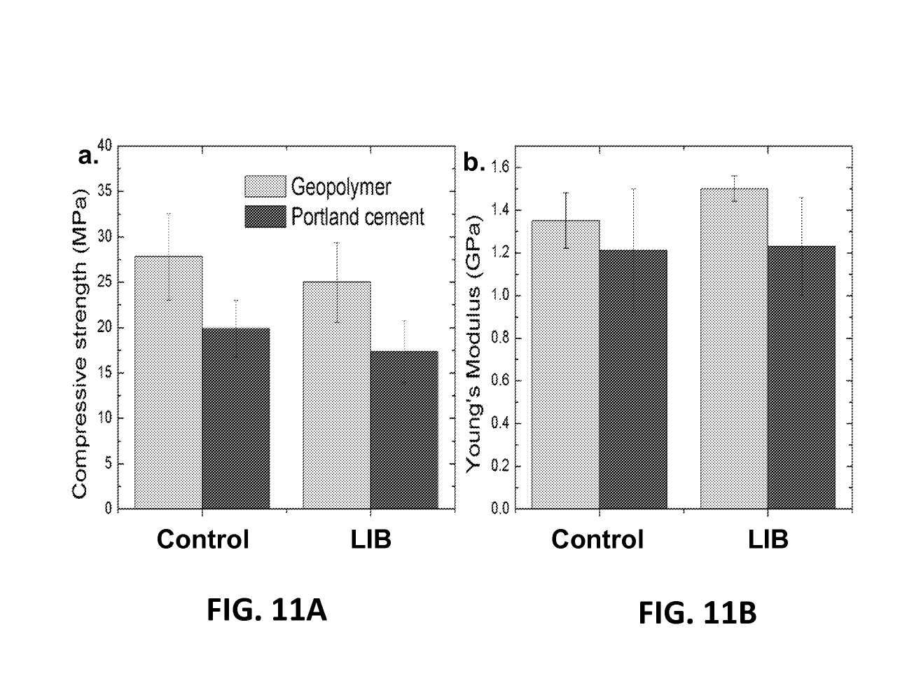

In addition to the wetting properties, the mechanical properties were also analyzed to determine if the chemical functionalization and infiltration of lubricant had any effect. These samples were prepared all within the same batch and were sealed in a closed container until they were actually tested. The overall compressive strength and Young's modulus of the SLIPS modified GP and PC samples after lubrication did not significantly change, which means that even with the chemical functionalization process the bulk mechanical properties of the material is still maintained (See FIGS. 11A and 11B).

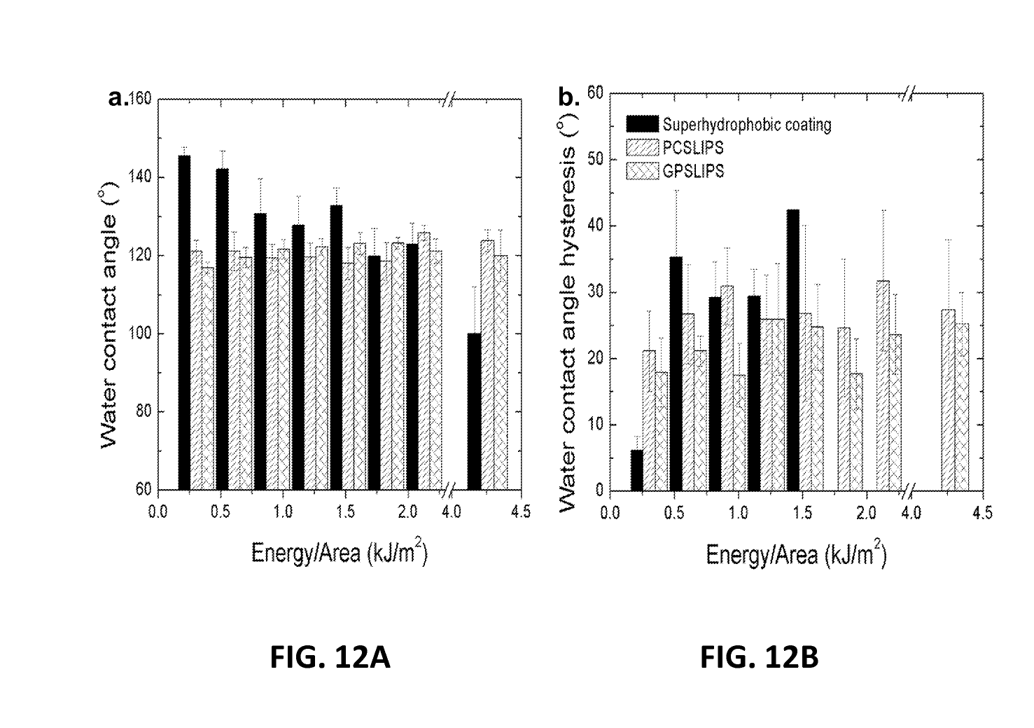

The durability of the sample was tested via a sand abrasion method using yttria-stabilized zirconia beads with varying diameters from 0.8 mm to 2 mm. The wetting properties of GP and PC (SLIPS) as well as a commercially available super hydrophobic coating applied on cement samples were compared. FIGS. 12A and 12B show the water contact angle (CA) and water contact angle hysteresis (CAH), respectively, as a function of total applied energy per sample area using sand drop method (larger energy represents larger zirconia beads being dropped). The CA and CAH data shown in FIGS. 12A and 12B, respectively, only represent when water droplets did not pin to the surface. In this set of experiments, the tendency of water droplets pinning were 50% on super hydrophobic coating, 25% on PCSLIPS, and 7% on GPSLIPS samples.

The super hydrophobic surface is shown to fail after 1.520±0.005 kJ/m² energy was applied, while the SLIPS samples were still able to maintain their original wetting properties. After the application of 1.520±0.005 kJ/m² the super hydrophobic surface had 100% pinned water droplets on the surface. As a result, water CAH could not be obtained beyond this point. The commercial super hydrophobic coating eventually failed after application of 4.527±0.013 kJ/m² and the surface began to display dynamic wetting properties.

The CAH of both GP and PC after the mechanical abrasion test varied slightly but did not increase significantly. As shown in FIG. 12A, the static water CA was observed to be consistently hydrophobic for both PC and GP through all abrasion tests studied, whereas the super hydrophobic coating began to display water CA below 90° after application of about 4.5 kJ/m².

### Example 5

### Application of Formulation to Existing Structures

Following the above outlined procedure for PC, a portion of a wall in an existing building is abraded using 600 grit paper where approximately 100 μm is removed. The chemical modifying agent solution (FS) is applied using an aerosol spray can and allowed to dry for 24 h. The liquid barrier layer is then applied in a similar fashion and allowed to infuse for 24 hours. The treated area exhibits repellency to liquids such as water.

### Example 6

### LIB for Ceramic Packing Materials for Reactors

In another example, LIB can also be applied to packing materials (for packed bed reactors) to improve flow dynamics of viscous materials around the packing material, following the above procedure outlined. Such packing materials can be composed of ceramics such as zeolites.

### Example 7

### Preservation of Archeological Monuments and Buildings

Due to the exceptional enhancement in the ability to withstand environmental exposure that the SLIPS modified cementitious material offer, in another example, this technology is envisaged to assist in the protection of archeological objects, such as, artifacts, monuments and buildings from damage, for example from, acid rains, corrosion, and graffiti. Coating the cementitious surfaces of historical buildings, monuments and structures with LIBs is expected to prolong their life.

### Example 8

### Mitigation of Plugging Issues in Separation Columns in a Nuclear Power Plant

Separation columns in nuclear power plants suffer from plugging issues due to the build up of by-product such as xanthane hydride (C₂H₂N₂S₃) that lead to frequent downtime and employee's time, additional materials and clean up cost. Coating the internal surface of ceramic based surfaces with SLIPS can mitigate such issues.

### Example 9

### Barrier Layer for Both Liquids and Gas for a Structure in Contact With Soil

It is practically impossible to apply any protective coating for an area of existing cementitous structures and installations that are already in contact with soil. By fully infiltrating with a lubricant, LIB can be formed near the boundary of the area in contact with soil. In this case, water or gas permeation from soil to the cementitious structure may still take place. However, further migration of such already penetrated water and gas can be effectively prevented by having a LIB near the boundary.

### Application Testing

The reliability of the cement based SLIPS systems are also examined according to common industry test standards to determine the feasibility of cement based SLIPS for real world applications. Specifically, prepared samples can be subjected to freeze-thaw cycling testing, bio-foul testing, acid resistance test and rapid chloride ion permeability testing. For all tests, the samples can be prepared according to the procedure previously outlined. The test methods are described below:

### Freeze-Thaw Test

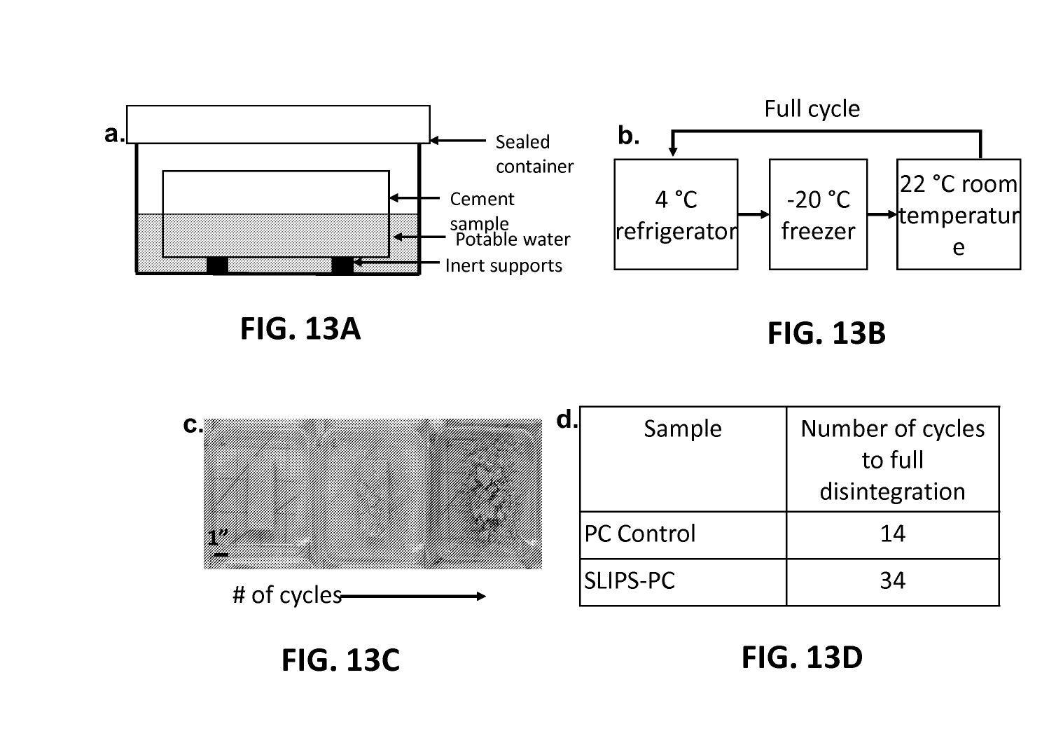

The test method used for freeze-thaw testing is adapted from ASTM C1262. Prepared GP and PC samples (control and SLIPS) can be partially submerged in potable water for 24 h and the mass gain was determined. The samples can then be transferred to sealed containers and were partially submerged in potable water (see FIG. 13A). The mass of the samples can be recorded before and after each cycle to determine the uptake of water within the samples. The samples can be cooled to −20° C. for 4 h and then heated to 22° C. for 4 h to simulate a representative freeze-thaw cycle, as shown in FIG. 13B. The samples can be qualitatively inspected after 10 cycles for deterioration and crack propagation as shown in FIG. 13C. Results show that SLIPS modified PC samples outperform untreated samples by lasting approximately twice as long, as shown in FIG. 13D.

Degradation due to extreme cold temperatures in concrete causes decreased mechanical stability over time. It may be beneficial to prevent adsorption of moisture and decrease chances of mechanical degradation due to freeze-thaw cycles. When water freezes it expands approximately 9% in volume. For PC the resistance to freeze-thaw cycle is dependent on the degree of saturation and pore distribution within the hardened cement. Water adsorption within the cement causes a variable range of damage from scaling on the surface to complete disintegration as the ice is formed. GP can be very resistant to freeze-thaw cycles. In addition, organic surface coatings have been used to prevent water adsorption in PC, however they tend to be high in volatile organic content and if there are any imperfections in the surface treatment then water is able to better settle underneath the coating. The application of a liquid barrier to cement materials can overcome the limitations that are associated with coatings and sealants that are currently used.

### Bio-Fouling Test

Microbial induced corrosion not only affects concretes but also corrodes reinforcement steel. As a result, there is the need to repair and sometimes even replace sewage systems to mitigate the damages caused. Though there are other mechanisms of corrosion including diffusion of ions, in environments with high concentrations of hydrogen sulfide (H₂S), oxygen and moisture, the predominant corrosion mechanism is caused by biogenic acid or more commonly known as sulfuric acid. Corrosion can be caused by sulfuric acid. Generally, H₂S is produced in anaerobic environments by sulfate-reducing bacteria. The H₂S permeates through the concrete and sulfur-oxidizing bacteria present in concrete reduce the H₂S to sulfuric acid leading to corrosion. In addition, cement grout that has incurred water damage promotes the growth of a wide range of microbial communities, some of which are pathogenic and have been linked to a number of diseases. This is the case in cementitious grout in residential and commercial communities. The common black mold (S. chartarum) is a toxigenic species of fungus that has been associated with health concerns such as pulmonary hemorrhage and hemosiderosis in infants. Thus, the inhibition of colonization and permeation of the bacteria through cementitious material is beneficial to reduce the chance of mechanical instability of the material as well as decreasing associated health risks.

GP and PC control and lubricated samples (2 in.×3 in.) can be prepared. The prepared samples can be tested against the growth of an ubiquitous fungi (Aspergellus niger). The fungi can be allowed to grow for two weeks in ambient conditions. The weight gain, coverage of organisms and the Young's modulus of the samples can be determined after a desired time. Sample sizes can be optimized for statistical analysis. Forming SLIPS over the cementitious material can provide increased resistance to bio-fouling.

In addition, samples can be prepared similarly as above and tested against the growth of algae such as Chlamydomonas reinhardtii where this is applicable for concrete in tidal range areas.

### Acid-Resistance Test

In addition to mechanical robustness, the cement used should also have a degree of resistance to chemical attacks, such that deterioration over time can be minimized. Common sources of acid include precipitation, byproducts of bacterial growth and/or pollution resulting from industrial processes. There are many types of chemical attacks that may occur and it is common to test the acid resistance of the cement used.

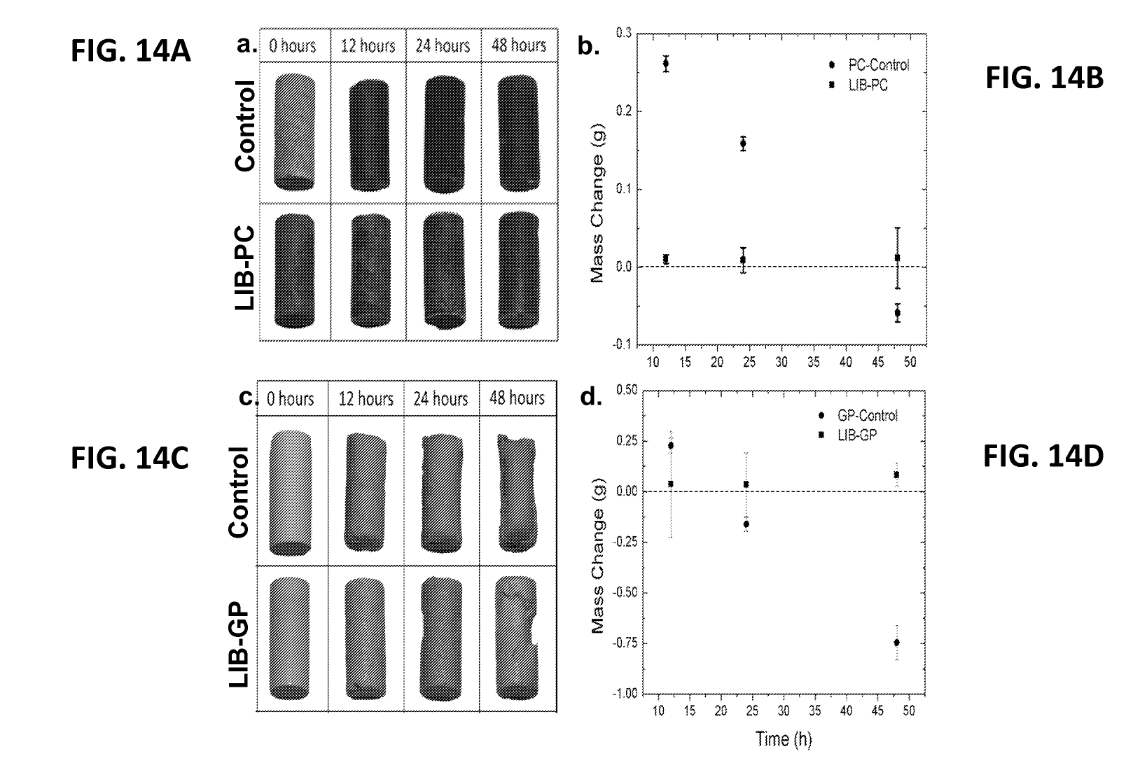

The method for acid resistance testing is adapted from ASTM C267 (International, ASTM C267, Standard Test Methods for Chemical Resistance of Mortars, Grouts and Monolithic Surfacings and Polymer Concretes, 2012). Samples (PC and LIB-PC) were completely submerged in 1 wt % hydrochloric acid (HCl) solution, prepared using reagent grade HCl (Sigma Aldrich). The initial weight, appearance of the samples, and appearance of the test medium were recorded. Cylindrical silicon molds with a diameter of 10 mm and a height that is slightly higher than 20 mm were used to prepare the samples. A diamond blade was used to precisely size samples to a height of 20±0.5 mm. A description of the color and surface appearance of the specimens, along with the color and clarity of the test medium were recorded (see FIGS. 14A-14D). A set of three samples was placed on their curved sides in a 250 mL cylindrical polypropylene container with an inert plastic divider to separate each sample. 100 mL of 1 wt % HCl solution was added to each container. The specimens were examined after 12, 24, and 48 h, recording the appearance and weight of the specimen and appearance of the test medium. After each examination period, the test medium was replaced with new medium. Samples were rinsed with deionized water and blotted dry with a lint free wipes before measuring the weight. Forming SLIP S on cementitious material provided increased resistance to degradation of the cementitious material through acid attack. This is apparent through the significantly reduced mass loss as compared to control samples.

### Rapid Chloride Ion Permeability Test

As previously mentioned, many problems that jeopardize the integrity of concrete are caused by increased permeability that allows the diffusion of water and ions through. The most destructive contaminant in concrete is the chloride ion because it participates in reactions that cause the dissolution of iron in concrete. In addition they are usually not completely consumed in the reaction and catalyze the change of iron to iron oxide forms. The formation of varying oxides leads to the adsorption of water onto the reinforcements allowing water to consume a larger volume. Inevitably, this causes expansion in the material which can lead to costly repair and maintenance to the concrete. This also decreases the bond strength between the reinforcements and can lead to delamination of the concrete. The corrosion of concrete has become a pressing issue and is close to almost an $8.3 billion national repair problem. The main sources of ions come from the use of deicing salt as well as marine environments.

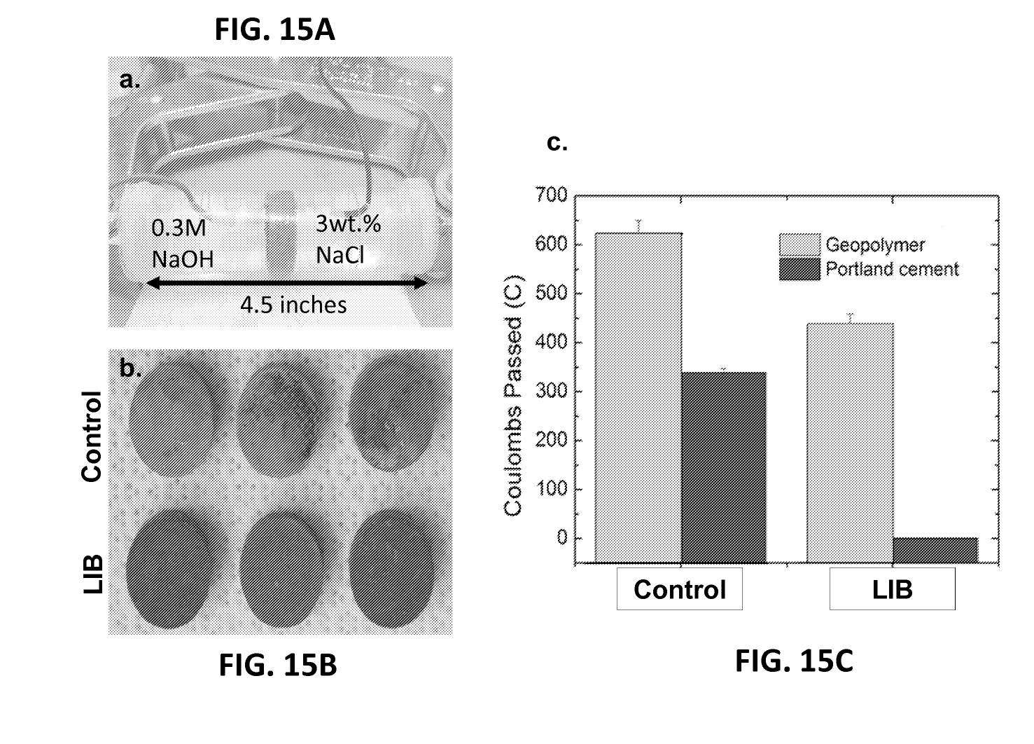

The test method used for rapid chloride ion permeability testing is adapted from ASTM C1202 and is shown in FIG. 15A. GP and PC samples after the test are shown in FIG. 15B. The working electrode used is stainless steel mesh. The test setup includes two compartments with equal volumes of a 3 wt % NaCl (Sigma) solution at the anode and a 0.3 N NaOH (reagent grade, Sigma) solution at the cathode. The sample is placed there between (analogous to a salt bridge) and exposed areas are coated with sealant to prevent leakage of solutions. A total potential of 11.43 V passed through the sample and the current is monitored for a duration of 6 h. The total charge passed through the sample is a measure of ion penetration and is correlated to the permeability using the following criteria:

| | Chloride ion |
|---|---|
| Charge passed (coulombs) | penetrability |
| >4000 | High |
| 2000-4000 | Moderate |
| 1000-2000 | Low |
| 100-1000 | Very low |
| <100 | Negligible |

Forming a SLIPS structure over the cementitious material can provide increased resistance to permeability of chloride ions as shown in FIG. 15C.

### Characterization Methods

The following characterization methods were utilized in the examples described above.

Scanning electron microscopy was performed using a Zeiss Ultra 55 and Tescan Vega III. Samples were degassed and polished using varying size grit papers. Cementitious materials were intrinsically non-conductive, and thus to avoid charging effects they were coated with a 5 nm platinum/palladium coating.

Energy dispersive x-ray spectroscopy was performed using Bruker Xflash 5030 and were uncoated.

X-ray fluorescence was performed using a Spectro Xepos XRF. Samples were analyzed under helium gas using three targets: Molybdenum, Alumina and Highly Oriented Pyrolytic Graphite with varying x-ray detection range.

Chemical surface functionalization was confirmed using a Thermo scientific K-alpha x-ray photoelectron spectrometer (XPS). Multi-point, high resolution and depth profiling scans were performed to obtain relevant spectra to confirm functionalization.

Compression tests were performed using an Intron Universal Testing Machine 5566. Cylindrical specimens were prepared with a 10 mm diameter and 20 mm length, maintaining an aspect ratio of 2:1. Prior to testing the samples were polished flat. An average of at least 3 samples were taken for each measurement.

The wetting properties of the samples were measured using a Krüss goniometer. Static water contact angles (8 μL) and contact angle hysteresis were determined using build-in regression best-fits for control (non-lubricated) samples. For lubricated samples the same parameters were measured, however measurements were performed using salt water as well.

Thermo gravimetric analysis (TGA) was performed using a Q5000IR (TA Instruments) to determine the amount of residual water present in the GP and PC samples.

It should be understood that the expression “at least one of” includes individually each of the recited objects after the expression and the various combinations of two or more of the recited objects unless otherwise understood from the context and use.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

The use of the singular herein, for example, “a,” “an,” and “the,” includes the plural (and vice versa) unless specifically stated otherwise.

Where the use of the term “about” is before a quantitative value, the present teachings also include the specific quantitative value itself, unless specifically stated otherwise. As used herein, the term “about” refers to a ±10% variation from the nominal value unless otherwise indicated or inferred.

It should be understood that the order of steps or order for performing certain actions is immaterial so long as the present teachings remain operable. Moreover, two or more steps or actions may be conducted simultaneously.

The use of any and all examples, or exemplary language herein, for example, “such as” or “including,” is intended merely to illustrate better the present teachings and does not pose a limitation on the scope of the invention unless claimed. No language in the specification should be construed as indicating any non-claimed element as essential to the practice of the present teachings.

Upon review of the description and embodiments provided herein, those skilled in the art will understand that modifications and equivalent substitutions may be performed in carrying out the invention without departing from the essence of the invention. Thus, the invention is not meant to be limiting by the embodiments described explicitly above.

1. A method comprising:
providing a cementitious material;
treating the cementitious material to remove water from the top surface of the cementitious material to a depth of at least 100 μm;
chemically functionalizing the cementitious material with one or more functional groups that have a chemical affinity with a liquid; and
wetting and adhering the liquid to the chemically functionalized cementitious material to fill one or more pores present in the cementitious material and form a liquid layer over the cementitious material;
wherein the liquid layer over the cementitious material provides a barrier to a foreign object

2. The method of claim 1 wherein the liquid wetted and adhered to the cementitious material forms a liquid infused barrier (LIB).

3. The method of claim 2, wherein the liquid wetted and adhered to the cementitious material fills at least some of the pores present in the cementitious material below the surface at a depth greater than 100 μm.

4. The method of claim 2, wherein the liquid wetted and adhered to the cementitious material fills substantially all of the pores in the cementitious material.

5. The method of claim 2, wherein the LIB provides an impermeable barrier layer against immiscible liquids and gases.

6. The method of claim 1, wherein the LIB is labile inside the cementitious material.

7. The method of claim 1, further comprising removing the top surface of the cementitious material to remove localized regions of elevated concentration of ionic species having a dimension greater than 10 μm.

8. The method of claim 1, wherein the one or more functional groups are selected from the group consisting of organosilicone compounds, long-chain unsubstituted alkyl silanes, fluorinated alkyl silanes, amines, thiols, carboxylic acids, phosphonic acids, sulfonic acids, polyethers, cycloethers, and combinations thereof.

9. The method of claim 1, wherein the liquid is selected from the group consisting of perflurorinated hydrocarbons, partially fluorinated hydrocarbons, organosilicone compounds, low molecular weight hydrocarbons, long-chain hydrocarbons, derivatives of long-chain hydrocarbons, ionic liquids, polyolefins, synthetic esters, polyalkylene glycols (PAG), phosphate esters, alkylated naphthalenes (AN), silicate esters, perfluoroalkylamines, perfluoroalkylsulfides, perfluoroalkylsulfoxides, perfluoroalkylethers, perfluorocycloethers, perfluoropolyethers, perfluoroalkylphosphines, perfluoroalkylphosphine oxides, perfluorocarbons, long-chain perfluorinated carboxylic acids, fluorinated phosphonic acids, fluorinated sulfonic acids, fluorinated silanes, and combinations thereof.

10. The method of claim 1, wherein said treating the cementitious material to remove water includes heating the cementitious material at a temperature below about 70° C.

11. The method of claim 10, wherein said treating the cementitious material to remove water is carried out for less than about 6 hours.

12. The method of claim 7, wherein said removing the top surface of the cementitious material includes grinding, sand blasting, cutting, polishing, or combinations thereof.

13-15. (canceled)

16. The method of claim 1, wherein said treating the cementitious material to remove water includes heating the surface of the cementitious material with a flame or bringing the surface in contact with a heated medium or another heated surface.

17. The method of claim 1, wherein said providing a cementitious material includes curing the cementitious material in the presence of water.

18. A method comprising:
providing a cementitious material having a plurality of localized regions with elevated concentration of ionic species;
removing the top surface of the cementitious material to expose a surface having a lower concentration of ionic species;
chemically functionalizing the cementitious material having a surface with a lower concentration of ionic species with one or more functional groups that have a chemical affinity with a liquid; and
wetting and adhering the liquid to the chemically functionalized cementitious material to fill one or more pores present in the cementitious material and form a liquid layer over the cementitious material;
wherein the liquid layer over the cementitious material provides a barrier to a foreign object.

19. The method of claim 18, wherein the said removing the top surface of the cementitious material to reduce the size of the localized regions with elevated concentration of ionic species is done till the average size of the localized regions with elevated concentration of ionic species is less than 10 μm.

20. The method of claim 18, further comprising treating the cementitious material to remove water from the cementitious material.

21. (canceled)

22. The method of claim 18, wherein the liquid is selected from the group consisting of perflurorinated hydrocarbons, partially fluorinated hydrocarbons, organosilicone compounds, low molecular weight hydrocarbons, long-chain hydrocarbons, derivatives of long-chain hydrocarbons, ionic liquids, polyolefins, synthetic esters, polyalkylene glycols (PAG), phosphate esters, alkylated naphthalenes (AN), silicate esters, perfluoroalkylamines, perfluoroalkylsulfides, perfluoroalkylsulfoxides, perfluoroalkylethers, perfluorocycloethers, perfluoropolyethers, perfluoroalkylphosphines, perfluoroalkylphosphine oxides, perfluorocarbons, long-chain perfluorinated carboxylic acids, fluorinated phosphonic acids, fluorinated sulfonic acids, fluorinated silanes, and combinations thereof.

23. The method of claim 18, wherein said treating the cementitious material to remove water includes heating the cementitious material at a temperature below 70° C.

24-30. (canceled)

31. The method of claim 18, wherein the liquid wetted and adhered to the cementitious material forms a liquid infused barrier (LIB).

32. The method of claim 31, wherein the liquid wetted and adhered to the cementitious material fills at least some of the pores present in the cementitious material below the surface at a depth greater than 100 μm.

33. The method of claim 31, wherein the liquid wetted and adhered to the cementitious material fills substantially all of the pores in the cementitious material.

34. The method of claim 31, wherein the LIB provides an impermeable barrier layer against immiscible liquids and gases.

35. (canceled)

36. A treated building comprising:
a building structure component comprising a cementititous material having a low concentration of ionic species with one or more functional groups that have a chemical affinity with a liquid near the top surface of the cementitious material; and
a liquid layer disposed over the chemically functionalized surface of cementitious material;
wherein the liquid layer comprises a liquid that wets and adheres the chemically functionalized cementitious material to fill one or more pores present in the cementitious material and form a liquid layer over the cementitious material;
wherein the liquid layer over the cementitious material provides a barrier to a foreign object.

37. The treated building of claim 36, wherein the liquid wetted and adhered to the cementitious material forms a liquid infused barrier (LIB).

38. The treated building of claim 37, wherein the liquid wetted and adhered to the cementitious material fills at least some of the pores present in the cementitious material below the surface at a depth greater than 100 μm.

39. The treated building of claim 37, wherein the liquid wetted and adhered to the cementitious material fills substantially all of the pores in the cementitious material.

40-50. (canceled)

51. The treated building of claim 36, wherein said cementitious material is a separation columns in nuclear power plants.

52. The treated building of claim 36, wherein said cementitious material is buried under soil.

53. A treated archeological object comprising:
a cementitious material having a low concentration of ionic species with one or more functional groups that have a chemical affinity with a liquid near the top surface of the cementitious material; and
a liquid layer disposed over the chemically functionalized surface of cementitious material;
wherein the liquid layer comprises a liquid that wets and adheres the chemically functionalized cementitious material to fill one or more pores present in the cementitious material and form a liquid layer over the cementitious material;
wherein the liquid layer over the cementitious material provides a barrier to a foreign object.
